(19) United States
(12) Patent Application Publication
(10) Pub. No.: US 2026/0077339 A1
(43) Pub. Date: Mar. 19, 2026

(54) CATALYST FOR THE TREATMENT OF AN EXHAUST GAS STREAM CONTAINING ONE OR MORE OF FORMALDEHYDE, NITROGEN OXIDE (NO), AND HYDROCARBONS HAVING A SPECIFIC MN LOADING

(71) Applicant: BASF CORPORATION, Florham Park, NJ (US)

(72) Inventors: Jeffrey B HOKE, Iselin, NJ (US); Shiang SUNG, Iselin, NJ (US)

(21) Appl. No.: 19/133,512

(22) PCT Filed: Dec. 4, 2023
(86) PCT No.: PCT/EP2023/084152

§ 371 Date: May 28, 2025

(30) Foreign Application Priority Data
Dec. 2, 2022 (EP) 22211098.3

(51) Int. Cl. B01J 23/656; B01D 53/86; B01J 29/00; B01J 35/57; B01J 37/02; F01N 3/28

(52) U.S. Cl. CPC B01J 23/6562; B01D 53/8628; B01D 53/8668; B01J 29/00; B01J 35/57; B01J 37/0215; F01N 3/2807; B01D 2257/40; B01D 2258/01

(57) ABSTRACT

A catalyst for the treatment of an exhaust gas stream containing one or more of formaldehyde, nitrogen oxide (NO), and hydrocarbons, the catalyst comprising a first washcoat layer comprising Mn, and a substrate, wherein the substrate has an inlet end, and an outlet end, wherein the catalyst further comprises one or more platinum group metals comprising Pt, Pd, or Pt and Pd, wherein the one or more platinum group metals are at least in part contained in one or more of: (a) the first washcoat layer, and (b) an optional second washcoat layer, or (c) optional second and third washcoat layers, wherein the loading of Mn in the catalyst, calculated as the element, is in the range of from 0.04 to 0.9 g/in3.

### TECHNICAL FIELD

The present invention relates to a catalyst for the treatment of an exhaust gas stream containing one or more of formaldehyde, nitrogen oxide (NO), and hydrocarbons, an exhaust gas treatment system comprising said catalyst, a method for the treatment of an exhaust gas stream containing one or more of formaldehyde, nitrogen oxide (NO), and hydrocarbons using said catalyst, and use of said catalyst for the oxidation of one or more of formaldehyde, nitrogen oxide (NO), and hydrocarbons.

### INTRODUCTION

The present invention relates to a diesel oxidation catalyst (DOC) with enhanced oxidation function, in particular with enhanced oxidation function of one or more of formaldehyde (HCHO), nitrogen oxide (NO), and hydrocarbons (including diesel fuel). It is known that formaldehyde is a toxic material that is coming under increasing regulation within indoor air spaces due to its re-lease from various building materials used in the construction industry. Tighter regulations are also being implemented for formaldehyde emissions from the engine exhaust of passenger and delivery vehicles. Generally, manganese oxides (e.g., MnO₂) are known to be active for destroying formaldehyde under ambient conditions, but they do not have the required thermal stability to survive in a typical engine exhaust environment. In particular, phase transitions at high temperature (e.g., higher than 400° C.) can cause the structure of MnO₂ to collapse such that the surface area and pore volume are so low as to be catalytically ineffective. One way to improve the stability of the Mn oxide at high temperature (as well as other catalytically useful base metal oxides such as copper, ceria and iron) can be to support them on refractory oxide materials which themselves have high stability when exposed to high temperatures in the engine exhaust. Materials such as aluminum oxide (Al₂O₃) and zirconium oxide (ZrO₂) can be useful in this regard.

The key challenge for inclusion of Mn-containing base metal oxide (BMO) catalysts in technology for abatement of exhaust emissions from diesel vehicles can be seen in the intrinsically poor sulfur resistance of manganese.

It is known that Pt and Pd supported on a high temperature resistant refractory metal oxide support provides efficient oxidation of CO and HC pollutants emitted from diesel engines. Such DOC compositions are needed by vehicle manufacturers to meet ever more stringent worldwide CO and HC exhaust emission requirements. An additional function of the DOC composition when placed in the exhaust of a diesel vehicle is to oxidize diesel fuel injected into the exhaust upstream of the DOC in order to create a high temperature exotherm that is used to thermally oxidize soot that has accumulated on a diesel particulate filter (DPF) or a catalyzed soot filter (CSF) located downstream of the DOC composition. Alternatively, the hydrocarbon concentration in the exhaust stream can be increased for exotherm generation by adjusting the combustion process through various post-injection methods or the like. Temperatures greater 600° C. at the DPF or CSF inlet are preferred to provide efficient oxidation of the retained soot. The concentration of diesel fuel injected into the exhaust stream needed to provide the desired exotherm is quite high, approximately 1% (10,000 ppm) on a C1 basis or more. The temperature at which the DOC composition can oxidize (“light-off”) the injected fuel needs to be as low as possible, preferably less than 300° C. In addition, the amount of hydrocarbon slip bypassing the DOC catalyst during exotherm generation needs to be as low as possible, preferably less than 3,000 ppm, 2,000 ppm or even 1,000 ppm.

WO 2022/047132 A1 relates to an oxidation catalyst composition for catalytic articles, exhaust gas treatment systems for reducing formaldehyde levels in engine exhaust emissions. In particular, an oxidation catalyst is disclosed in claim 1 comprising a platinum group metal (PGM) component comprising Pd, Pt, or a combination thereof, a manganese component, and a first refractory metal oxide support material comprising zirconia.

U.S. Pat. No. 10,598,061 B2 relates to methods and systems for a diesel oxidation catalyst. In particular, a method is disclosed in claim 1 comprising: generating NO₂ in a catalyst comprising a washcoat with zirconium, one or more base metal oxides, and a palladium oxide, with an exhaust gas flow rate being between lower and upper threshold flow rates; and facilitating a regeneration of a particulate filter located downstream of the catalyst via NO₂ when an exhaust gas temperature is greater than a threshold temperature where the palladium oxide is contained in an upstream portion of the catalyst relative to a direction of exhaust gas flow; and the one or more base metal oxides are contained in a downstream portion of the catalyst relative to the direction of exhaust gas flow.

U.S. Pat. No. 10,392,980 B2 relates to methods and systems for a diesel oxidation catalyst. In particular, a method is disclosed in claim 1 comprising: passing diesel combustion exhaust gas over a diesel oxidation catalyst having a washcoat comprising zirconium oxide, palladium oxide, and at least one base metal oxide, the washcoat coated on a surface of a substrate with the at least one base metal oxide coated to a downstream portion of the substrate in a greater amount than coated to an upstream portion and the palladium oxide coated to the upstream portion of the substrate in a greater amount than coated to the downstream portion, downstream referring to an axial direction of exhaust gas flow, and where the palladium oxide is 0.5-3 weight percent of the washcoat.

WO 2021/198680 A1 relates to an oxidation catalyst for a diesel engine and to an exhaust system for a diesel engine comprising the oxidation catalyst. According to claim 1, the layered diesel oxidation catalyst for treatment of exhaust gas emissions from a diesel engine comprises a flow-through monolith substrate having a honeycomb structure and comprising a front zone and a rear zone, wherein the front zone of the substrate comprises a combination of layers, one on top of another and comprising two or more of specific layers A, B and C; and the rear zone comprises a specific layer D.

US 2019/262772 A1 relates to an oxidation catalyst for a diesel engine and to an exhaust system for a diesel engine comprising the oxidation catalyst. In particular, an oxidation catalyst for treating an exhaust gas from a diesel engine is defined in claim 1, comprising: a first washcoat region comprising Pt, Mn and a first support material; a second washcoat region comprising a platinum group metal and a second support material; and a substrate having an inlet end and an outlet end; wherein the second washcoat region is arranged to contact the exhaust gas at the outlet end of the substrate and after contact of the exhaust gas with the first washcoat region.

US 2017/009623 A1 relates to a catalyst for storing nitrogen oxides (NOx) in an exhaust gas from a lean burn engine. In particular, a catalyst for storing nitrogen oxides in an exhaust gas from a lean burn engine is defined in claims 1, the catalyst comprising a NOx storage material and a substrate, wherein the NOx storage material comprises a NOx storage component and an NO oxidation promoter on a support material, wherein the NO oxidation promoter is manganese or an oxide, hydroxide or carbonate thereof.

US 2015/352493 A1 pertains to catalytic articles, and particularly those that contain both platinum group metals as well as non-platinum group metals. In particular, a catalytic article is defined in claim 1, the catalyst comprising a first catalytic coating comprising a platinum group metal, wherein the first catalytic coating is substantially free of Cu, Ni, Fe, Mn, V, Co, Ga, Mo, Mg, Cr and Zn; a second catalytic coating comprising a non-PGM metal, wherein the second catalytic coating is substantially free of a platinum group metal; and one or more substrates, wherein the first catalytic coating is separated from the second catalytic coating.

US 2018/318805 A1 relates to a diesel oxidation catalyst composition, catalyst articles coated with such a composition, emission treatment systems comprising such a catalyst article, and methods of use thereof. In particular, a diesel oxidation catalyst composition is defined in claim 1, the composition comprising at least one platinum group metal impregnated onto a porous refractory oxide material in particulate form and at least one base metal oxide impregnated onto a porous refractory oxide material in particulate form, wherein the porous refractory oxide material impregnated with at least one platinum group metal and the porous refractory oxide material impregnated with at least one base metal oxide are in the form of a mixture or wherein the at least one platinum group metal and the at least one base metal oxide are impregnated on the same porous refractory oxide material.

M. C. Álvarez-Galván et al. disclose in Applied Catalysis B. 2004, 51, 83-91 alumina-supported manganese catalysts with manganese loadings ranging from 3.9 to 18.2 wt. %. Said catalysts were prepared and tested in the combustion of formaldehyde/methanol mixture in an air stream.

Therefore, it was an object of the present invention to provide a catalyst having an improved performance with respect to the conversion of one or more of formaldehyde, nitrogen oxide (NO), and hydrocarbons, in particular after being exposed to a sulfation and de-sulfation treatment.

It has surprisingly been found that an improved catalyst can be provided for the conversion of one or more of formaldehyde, nitrogen oxide (NO), and hydrocarbons in an exhaust gas. In particular, it has been surprisingly found that a catalyst can be provided showing an improved performance with respect to the conversion of one or more of formaldehyde, nitrogen oxide (NO), and hydrocarbons after being exposed to a sulfation and de-sulfation treatment as encountered in a typical application. Furthermore, it has been surprisingly found that the catalyst according to the present invention shows enhanced hydrocarbon (HC) and nitrogen oxide (NO) oxidation function. In particular, it has surprisingly been found that the benefit of using BMO-containing catalyst to reduce platinum group metal in diesel exhaust treatment systems is not limited only to HCHO oxidation, but also to hydrocarbon and NO oxidation. This enables vehicle manufacturers to meet ever tightening vehicle emissions standards while also reducing overall PGM usage and costs. It has also been surprisingly found that use of a diesel oxidation catalyst (DOC) comprising both a platinum group metal (PGM) and a base metal oxide (BMO) catalyst leads to a catalyst having enhanced fuel burning function. Furthermore, it can be expected that the catalyst of the present invention is able to oxidize soot accumulation on a substrate, in particular on a wall-flow substrate, especially since the Mn-containing washcoat layer can generate NO₂ which oxidizes soot. Additionally, the catalyst of the present invention can enable a comparatively lower N₂O production, in particular due to its comparatively lower content of platinum group metals.

Therefore, the present invention relates to a catalyst for the treatment of an exhaust gas stream containing one or more of formaldehyde, nitrogen oxide (NO), and hydrocarbons, the catalyst comprising
a first washcoat layer comprising Mn, and
a substrate,
   wherein the substrate has an inlet end through which the exhaust gas stream may enter the catalyst, and an outlet end through which the exhaust gas stream may exit the catalyst, wherein the catalyst further comprises one or more platinum group metals comprising Pt, Pd, or Pt and Pd, wherein the one or more platinum group metals are at least in part contained in one or more of:
(a) the first washcoat layer, and
(b) an optional second washcoat layer, or
(c) optional second and third washcoat layers,
   wherein the loading of Mn in the catalyst, calculated as the element, is in the range of from 0.04 to 0.9 g/in³, preferably of from 0.05 to 0.8 g/in³, more preferably of from 0.06 to 0.7 g/in³, more preferably of from 0.07 to 0.6 g/in³, more preferably of from 0.08 to 0.5 g/in³, more preferably of from 0.1 to 0.25 g/in³, more preferably of from 0.12 to 0.22 g/in³, more preferably of from 0.14 to 0.2 g/in³, more preferably of from 0.16 to 0.18 g/in³.

It is preferred that the optional second washcoat layer is substantially free of Mn, wherein more preferably the optional second washcoat layer is free of Mn. It is noted that Mn contained in the second washcoat layer may result from the leaking thereof into said layer from another layer containing Mn, in particular from the first washcoat layer.

Within the meaning of the present invention, a washcoat layer is substantially free of an element or compound(s) when the washcoat layer contains said element or compound(s) in an amount of 1 wt.-% or less calculated as the element or compound(s) and based on 100 wt.-% of the washcoat layer, preferably in an amount of 0.5 wt.-% or less, more preferably of 0.1 wt.-% or less, more preferably of 0.05 wt.-% or less, more preferably of 0.01 wt.-% or less, more preferably of 0.005 wt.-% or less, and more preferably of 0.001 wt.-% or less.

It is preferred that the loading of Mn, calculated as the element, in the first washcoat layer is in the range of from 1 to 50 wt.-% based on 100 wt.-% of the first washcoat layer, more preferably from 2 to 30 wt.-%, more preferably from 5 to 20 wt.-%, more preferably from 8 to 12 wt.-%.

It is preferred that Mn is present in the form of one or more cations of Mn, wherein Mn is more preferably contained in the first washcoat layer as one or more oxides, wherein Mn is more preferably contained in the first washcoat layer as one or more oxides of Mn(II), Mn(III), Mn(II/III), and Mn(IV), more preferably as one or more oxides selected from the group consisting of MnO, Mn₂O₃, Mn₃O₄, MnO₂, Mn(O)OH, and Mn—Zr mixed oxides, including mixtures of two or more thereof, wherein the Mn-Zr mixed oxides are preferably contained in the first washcoat layer as a solid solution.

It is preferred that the first washcoat layer comprises a particulate support material, wherein Mn is supported on the particulate support material, wherein the particulate support material is more preferably selected from the group consisting of ZrO₂, Al₂O₃, SiO₂, TiO₂, La₂O₃-doped ZrO₂, CeO₂—ZrO₂ mixed oxide, La₂O₃-doped CeO₂—ZrO₂ mixed oxide, Nd₂O₃-doped CeO₂—ZrO₂ mixed oxide, Y₂O₃-doped CeO₂—ZrO₂ mixed oxide, praseodymium oxide-doped CeO₂—ZrO₂ mixed oxide, ZrO₂-doped Al₂O₃, ZrO₂-doped SiO₂, SiO₂-doped Al₂O₃, CuO—Al₂O₃ mixed oxide, and mixtures of two or more thereof, more preferably from the group consisting of ZrO₂, La₂O₃-doped ZrO₂, CeO₂—ZrO₂ mixed oxide, La₂O₃-doped CeO₂—ZrO₂ mixed oxide, Nd₂O₃-doped CeO₂—ZrO₂ mixed oxide, Y₂O₃-doped CeO₂—ZrO₂ mixed oxide, Pr₂O₃-doped CeO₂—ZrO₂ mixed oxide, Pr₆O₁₁-doped CeO₂—ZrO₂ mixed oxide, PrO₂-doped CeO₂—ZrO₂ mixed oxide, ZrO₂-doped Al₂O₃, ZrO₂-doped SiO₂, and mixtures of two or more thereof, more preferably from the group consisting of ZrO₂, La₂O₃-doped ZrO₂, CeO₂—ZrO₂ mixed oxide, La₂O₃-doped CeO₂—ZrO₂ mixed oxide, Nd₂O₃-doped CeO₂—ZrO₂ mixed oxide, Y₂O₃-doped CeO₂—ZrO₂ mixed oxide, Pr₂O₃-doped CeO₂—ZrO₂ mixed oxide, Pr₆O₁₁-doped CeO₂—ZrO₂ mixed oxide, and mixtures of two or more thereof, wherein more preferably Mn is supported on particulate La₂O₃-doped ZrO₂, wherein preferably ZrO₂ is doped with La₂O₃ in an amount ranging from 1 to 50 wt. % based on 100 wt.-% of ZrO₂ and La₂O₃, preferably from 3 to 30 wt.-%, more preferably from 5 to 15 wt.-%, more preferably from 8 to 10 wt.-%.

It is preferred that the first washcoat layer comprises Ce, wherein Ce is more preferably contained in the first washcoat layer as CeO₂ and/or Ce₂O₃.

In the case where the first washcoat layer comprises Ce, it is preferred that the loading of Ce, calculated as the element, in the first washcoat layer is in the range of from 1 to 50 wt.-% based on 100 wt.-% of the first washcoat layer, more preferably from 2 to 30 wt.-%, more preferably from 5 to 20 wt.-%, more preferably from 8 to 12 wt.-%.

Further in the case where the first washcoat layer comprises Ce, it is preferred that Ce is supported on a particulate support material, wherein the particulate support material is more preferably selected from the group consisting of ZrO₂, Al₂O₃, SiO₂, TiO₂, La₂O₃-doped ZrO₂, CeO₂—ZrO₂ mixed oxide, La₂O₃-doped CeO₂—ZrO₂ mixed oxide, Nd₂O₃-doped CeO₂—ZrO₂ mixed oxide, Y₂O₃-doped CeO₂—ZrO₂ mixed oxide, praseodymium oxide-doped CeO₂—ZrO₂ mixed oxide, ZrO₂-doped Al₂O₃, ZrO₂-doped SiO₂, SiO₂-doped Al₂O₃, CuO—Al₂O₃ mixed oxide, and mixtures of two or more thereof, more preferably from the group consisting of ZrO₂, La₂O₃-doped ZrO₂, CeO₂—ZrO₂ mixed oxide, La₂O₃-doped CeO₂—ZrO₂ mixed oxide, Nd₂O₃-doped CeO₂—ZrO₂ mixed oxide, Y₂O₃-doped CeO₂—ZrO₂ mixed oxide, Pr₂O₃-doped CeO₂—ZrO₂ mixed oxide, Pr₆O₁₁-doped CeO₂—ZrO₂ mixed oxide, PrO₂-doped CeO₂—ZrO₂ mixed oxide, ZrO₂-doped Al₂O₃, ZrO₂-doped SiO₂, and mixtures of two or more thereof, more preferably from the group consisting of ZrO₂, La₂O₃-doped ZrO₂, CeO₂—ZrO₂ mixed oxide, La₂O₃-doped CeO₂—ZrO₂ mixed oxide, Nd₂O₃-doped CeO₂—ZrO₂ mixed oxide, Y₂O₃-doped CeO₂—ZrO₂ mixed oxide, Pr₂O₃-doped CeO₂—ZrO₂ mixed oxide, Pr₆O₁₁-doped CeO₂—ZrO₂ mixed oxide, and mixtures of two or more thereof, wherein more preferably Ce is supported on particulate La₂O₃-doped ZrO₂, wherein preferably ZrO₂ is doped with La₂O₃ in an amount ranging from 1 to 50 wt. % based on 100 wt.-% of ZrO₂ and La₂O₃, preferably from 3 to 30 wt.-%, more preferably from 5 to 15 wt.-%, more preferably from 8 to 10 wt.-%.

Alternatively, it is preferred that the first washcoat layer is substantially free of Ce, wherein preferably the first washcoat layer is free of Ce.

In the case where the first washcoat layer is substantially free of Ce, it is preferred that the catalyst is substantially free of Ce, wherein more preferably the catalyst is free of Ce.

It is preferred that the first washcoat layer comprises Cu, wherein the first washcoat layer preferably comprises CuO, Cu₂O, or CuO and Cu₂O, more preferably CuO.

In the case where the first washcoat layer comprises Cu, it is preferred that the loading of Cu, calculated as the element, in the first washcoat layer is in the range of from 1 to 50 wt.-% based on 100 wt.-% of the first washcoat layer, more preferably from 2 to 30 wt.-%, more preferably from 5 to 20 wt.-%, more preferably from 8 to 12 wt.-%.

Further in the case where the first washcoat layer comprises Cu, it is preferred that Cu is supported on a particulate support material, wherein the particulate support material is more preferably selected from the group consisting of ZrO₂, Al₂O₃, SiO₂, TiO₂, La₂O₃-doped ZrO₂, CeO₂—ZrO₂ mixed oxide, La₂O₃-doped CeO₂—ZrO₂ mixed oxide, Nd₂O₃-doped CeO₂—ZrO₂ mixed oxide, Y₂O₃-doped CeO₂—ZrO₂ mixed oxide, praseodymium oxide-doped CeO₂—ZrO₂ mixed oxide, ZrO₂-doped Al₂O₃, ZrO₂-doped SiO₂, SiO₂-doped Al₂O₃, CuO—Al₂O₃ mixed oxide, and mixtures of two or more thereof, more preferably from the group consisting of ZrO₂, La₂O₃-doped ZrO₂, CeO₂—ZrO₂ mixed oxide, La₂O₃-doped CeO₂—ZrO₂ mixed oxide, Nd₂O₃-doped CeO₂—ZrO₂ mixed oxide, Y₂O₃-doped CeO₂—ZrO₂ mixed oxide, Pr₂O₃-doped CeO₂—ZrO₂ mixed oxide, PreO₁₁-doped CeO₂—ZrO₂ mixed oxide, PrO₂-doped CeO₂—ZrO₂ mixed oxide, ZrO₂-doped Al₂O₃, ZrO₂-doped SiO₂, and mixtures of two or more thereof, more preferably from the group consisting of ZrO₂, La₂O₃-doped ZrO₂, CeO₂—ZrO₂ mixed oxide, La₂O₃-doped CeO₂—ZrO₂ mixed oxide, Nd₂O₃-doped CeO₂—ZrO₂ mixed oxide, Y₂O₃-doped CeO₂—ZrO₂ mixed oxide, Pr₂O₃-doped CeO₂—ZrO₂ mixed oxide, Pr₆O₁₁-doped CeO₂—ZrO₂ mixed oxide, and mixtures of two or more thereof, wherein more preferably Cu is supported on particulate La₂O₃-doped ZrO₂, wherein preferably ZrO₂ is doped with La₂O₃ in an amount ranging from 1 to 50 wt. % based on 100 wt.-% of ZrO2 and La₂O₃, preferably from 3 to 30 wt.-%, more preferably from 5 to 15 wt.-%, more preferably from 8 to 10 wt.-%.

Alternatively, it is preferred that the first washcoat layer is substantially free of Cu, wherein more preferably the first washcoat layer is free of Cu.

In the case where the first washcoat layer is substantially free of Cu, it is preferred that the catalyst is substantially free of Cu, wherein more preferably the catalyst is free of Cu.

It is preferred that the substrate is a wall-flow substrate or a flow-through substrate, more preferably a honeycomb wall-flow substrate or a honeycomb flow-through substrate, more preferably a honeycomb flow-through substrate, wherein the flow-through substrate is more preferably a flow-through substrate with high porosity walls.

It is preferred that the loading of the first washcoat layer is in the range of from 0.3 to 6 g/in³, more preferably of from 1 to 5 g/in³, more preferably of from 1.5 to 4 g/in³, more preferably of from 2 to 3.5 g/in³, more preferably of from 2.3 to 2.9 g/in³, more preferably of from 2.5 to 2.7 g/in³.

Within the meaning of the present invention, the loading of a washcoat layer in the catalyst refers to the loading of said washcoat layer based on the volume of the catalyst in which said washcoat layer is contained. Accordingly, within the meaning of the present invention, the loading of a washcoat layer only contained in a certain portion or zone of the catalyst is based on the volume of that portion or zone of the catalyst. Thus, by means of examples, if a washcoat layer is provided over 50% of the axial length of a honeycomb substrate, its loading is calculated based on 50% of the total volume of the honeycomb substrate.

It is preferred that the loading of the second washcoat layer is in the range of from 0.25 to 6 g/in³, preferably of from 0.3 to 6 g/in³, more preferably of from 1 to 5 g/in³, more preferably of from 1.5 to 4 g/in³, more preferably of from 2 to 3.5 g/in³, more preferably of from 2.2 to 3.0 g/in³, more preferably of from 2.3 to 2.9 g/in³, more preferably of from 2.5 to 2.7 g/in³.

It is preferred that the catalyst comprises one or more platinum group metals consisting of Pt, Pd, or Pt and Pd, wherein more preferably the catalyst comprises Pt, or Pt and Pd as the one or more platinum group metals, wherein more preferably the catalyst comprises Pt and Pd as the one or more platinum group metals.

It is preferred that the catalyst comprises Pt, calculated as the element, at a loading in the range of from 2 to 250 g/ft³, more preferably of from 5 to 150 g/ft³, more preferably of from 10 to 125 g/ft³, more preferably of from 20 to 100 g/ft³, more preferably of from 25 to 85 g/ft³, more preferably of from 30 to 80 g/ft³, more preferably of from 40 to 60 g/ft³.

Within the meaning of the present invention, the loading of Pt, Pd, or Pt and Pd in the catalyst refers to the loading of Pt, Pd, or Pt and Pd based on the volume of the catalyst in which Pt, Pd, or Pt and Pd is contained. In the event that Pt, Pd, or Pt and Pd is contained in one or more zones of the catalyst, it is preferred within the meaning of the present invention, that the loading of Pt, Pd, or Pt and Pd is based on the volume of the catalyst in which the one or more Pt, Pd, or Pt and Pd zones are contained. Thus, by means of examples, if Pt, Pd, or Pt and Pd is provided in a zone extending over 50% of the axial length of a honeycomb substrate, its loading is calculated based on 50% of the total volume of the honeycomb substrate.

It is preferred that the catalyst comprises Pd, calculated as the element, at a loading in the range of from 5 to 100 g/ft³, more preferably of from 5 to 60 g/ft³, more preferably of from 10 to 50 g/ft³, more preferably of from 15 to 40 g/ft³, more preferably of from 20 to 30 g/ft³.

It is preferred that the catalyst comprises Pt and Pd, calculated as the respective element, at a total Pt and Pd loading in the range of from 2 to 250 g/ft³, more preferably of from 5 to 200 g/ft³, more preferably of from 10 to 150 g/ft³, more preferably of from 20 to 130 g/ft³, more preferably of from 30 to 125 g/ft³, more preferably of from 40 to 110 g/ft³, more preferably of from 50 to 100 g/ft³, more preferably of from 60 to 90 g/ft³, more preferably of from 70 to 80 g/ft³.

It is preferred that the catalyst comprises Pt and Pd at a Pt: Pd weight ratio in the range of from 1:2 to 20:1, more preferably of from 50:50 to 80:20, more preferably of from 60:40 to 75:25, more preferably of from 65:35 to 70:30.

It is preferred that the one or more platinum group metals are supported on a particulate support material, wherein the particulate support material is more preferably selected from the group consisting of Al₂O₃, SiO₂, TiO₂, SiO₂-doped Al₂O₃, Mn oxide-doped Al₂O₃, and mixtures of two or more thereof, wherein more preferably the one or more platinum group metals are supported on Al₂O₃ and/or SiO₂-doped Al₂O₃ and/or Mn oxide-doped Al₂O₃, more preferably SiO₂-doped Al₂O₃ or Al₂O₃ or Mn oxide-doped Al₂O₃, wherein the Mn oxide-doped Al₂O₃ preferably comprises from 1 to 10 weight-%, more preferably from 4 to 6 weight-%, of Mn oxide, calculated as Mn oxide, based on 100 weight-% of the Mn oxide-doped Al₂O₃.

It is preferred that the first washcoat layer comprises a hydrocarbon trap material, wherein the hydrocarbon trap material comprises a molecular sieve, more preferably a zeolite, more preferably a zeolite having a maximum pore size of 12-membered rings, more preferably zeolite beta, wherein the molecular sieve, more preferably the zeolite, more preferably comprises SiO₂ and Al₂O₃, wherein the molecular sieve, more preferably the zeolite, more preferably has a molar ratio of SiO₂ to Al₂O₃ in the range of from 10:1 to 500:1, more preferably of from 10:1 to 100:1, more preferably of from 10:1 to 40:1, more preferably of from 15:1 to 30:1, more preferably of from 20:1 to 25:1, wherein the molecular sieve, more preferably the zeolite, more preferably comprises Fe, wherein the molecular sieve, preferably the zeolite, more preferably comprises Fe, calculated as Fe₂O₃, in an amount in the range of from 1.0 to 7.0 weight-%, more preferably of from 3.0 to 5.0 weight-%, more preferably of from 4.0 to 4.5 weight-%, based on the weight of the molecular sieve.

In the case wherein the first washcoat layer comprises a hydrocarbon trap material, it is preferred that the loading of the hydrocarbon trap material in the first washcoat layer is in the range of from 0.01 to 2.0 g/in³, more preferably in the range of from 0.05 to 1.0 g/in³, more preferably in the range of from 0.05 to 0.3 g/in³.

It is preferred that the catalyst comprises a second washcoat layer, wherein the one or more platinum group metals are at least in part contained in the second washcoat layer, wherein more preferably the one or more platinum group metals are entirely contained in the second washcoat layer.

It is preferred that the second washcoat layer comprises a hydrocarbon trap material, wherein the hydrocarbon trap material comprises a molecular sieve, more preferably a zeolite, more preferably a zeolite having a maximum pore size defined by 12-membered rings, more preferably zeolite beta, wherein the molecular sieve, preferably the zeolite, preferably comprises SiO₂ and Al₂O₃, wherein the molecular sieve, preferably the zeolite, more preferably has a molar ratio of SiO₂ to Al₂O₃ in the range of from 10:1 to 40:1, more preferably of from 15:1 to 30:1, more preferably of from 20:1 to 25:1, wherein the molecular sieve, preferably the zeolite, preferably comprises Fe, wherein the molecular sieve, preferably the zeolite, more preferably comprises Fe, calculated as Fe₂O₃, in an amount in the range of from 1.0 to 7.0 weight-%, more preferably of from 3.0 to 5.0 weight-%, more preferably of from 4.0 to 4.5 weight-%, based on the weight of the molecular sieve.

In the case where the second washcoat layer comprises a hydrocarbon trap material, wherein the hydrocarbon trap material comprises a molecular sieve, it is preferred that the loading of the hydrocarbon trap material in the second washcoat layer is in the range of from 0.01 to 2.0 g/in³, more preferably in the range of from 0.05 to 1.0 g/in³ g/in³, more preferably in the range of from 0.05 to 0.3 g/in³.

According to a first alternative, it is preferred that the catalyst comprises a second washcoat layer, wherein the catalyst displays a layered arrangement of the first and second washcoat layers, and wherein the one or more platinum group metals are at least in part contained in the second washcoat layer.

In the case where the catalyst comprises a second washcoat layer, wherein the catalyst displays a layered arrangement of the first and second washcoat layers, and wherein the one or more platinum group metals are at least in part contained in the second washcoat layer, in accordance with the first alternative, it is preferred that the first washcoat layer is provided on the substrate, and the second washcoat layer is provided on the first washcoat layer.

Further in the case where the catalyst comprises a second washcoat layer, wherein the catalyst displays a layered arrangement of the first and second washcoat layers, and wherein the one or more platinum group metals are at least in part contained in the second washcoat layer, in accordance with the first alternative, it is preferred that the second washcoat layer is provided on the substrate, and the first washcoat layer is provided on the second washcoat layer.

Further in the case where the catalyst comprises a second washcoat layer, wherein the catalyst displays a layered arrangement of the first and second washcoat layers, and wherein the one or more platinum group metals are at least in part contained in the second washcoat layer, in accordance with the first alternative, it is preferred that the catalyst comprises a third washcoat layer, wherein the catalyst displays a zoned arrangement of the first, second, and third washcoat layers, wherein the third washcoat layer is provided on the substrate along its axial length starting from the inlet end of the substrate and wherein the first washcoat layer is provided on the substrate along its axial length starting from the outlet end of the substrate, and wherein the second washcoat layer is provided on and entirely covers the first washcoat layer, wherein the length of the first washcoat layer is less than the axial length of the substrate such as to create an upstream zone comprising the third washcoat layer and a downstream zone comprising the first and second washcoat layers, and wherein the one or more platinum group metals are at least in part contained in the third washcoat layer. Alternatively, it is preferred that the catalyst comprises a third washcoat layer, wherein the catalyst displays a zoned arrangement of the first, second, and third washcoat layers, wherein the third washcoat layer is provided on the substrate along its axial length starting from the inlet end of the substrate and wherein the second washcoat layer is provided on the substrate along its axial length starting from the outlet end of the substrate, and wherein the first washcoat layer is provided on and entirely covers the second washcoat layer, wherein the length of the second washcoat layer is less than the axial length of the substrate such as to create an upstream zone comprising the third washcoat layer and a downstream zone comprising the first and second washcoat layers, and wherein the one or more platinum group metals are at least in part contained in the third washcoat layer. Alternatively, it is preferred that the catalyst comprises a third washcoat layer, wherein the catalyst displays a zoned arrangement of the first, second, and third washcoat layers, wherein the third washcoat layer is provided on the substrate along its axial length starting from the outlet end of the substrate and wherein the first washcoat layer is provided on the substrate along its axial length starting from the inlet end of the substrate, and wherein the second washcoat layer is provided on and entirely covers the first washcoat layer, wherein the length of the first washcoat layer is less than the axial length of the substrate such as to create a downstream zone comprising the third washcoat layer and an upstream zone comprising the first and second washcoat layers, and wherein the one or more platinum group metals are at least in part contained in the third washcoat layer. Alternatively, it is preferred that the catalyst comprises a third washcoat layer, wherein the catalyst displays a zoned arrangement of the first, second, and third washcoat layers, wherein the third washcoat layer is provided on the substrate along its axial length starting from the outlet end of the substrate and wherein the second washcoat layer is provided on the substrate along its axial length starting from the inlet end of the substrate, and wherein the first washcoat layer is provided on and entirely covers the second washcoat layer, wherein the length of the second washcoat layer is less than the axial length of the substrate such as to create a downstream zone comprising the third washcoat layer and an upstream zone comprising the first and second washcoat layers, and wherein the one or more platinum group metals are at least in part contained in the third washcoat layer.

According to a second alternative, it is preferred that the catalyst comprises a second washcoat layer, wherein the catalyst displays a zoned arrangement of the first and second washcoat layers, wherein the second washcoat layer is provided on the substrate along its axial length starting from the inlet end of the substrate, and wherein the first washcoat layer is provided on the substrate along its axial length starting from the outlet end of the substrate, wherein the length of the first washcoat layer is less than the axial length of the substrate such as to create an upstream zone comprising the second washcoat layer and a downstream zone comprising the first washcoat layer, and wherein the one or more platinum group metals are at least in part contained in the second washcoat layer.

According to a third alternative, it is preferred that the catalyst comprises a second washcoat layer, wherein the catalyst displays a zoned arrangement of the first and second washcoat layers, wherein the first washcoat layer is provided on the substrate along its axial length starting from the inlet end of the substrate, and wherein the second washcoat layer is provided on the substrate along its axial length starting from the outlet end of the substrate, wherein the length of the first washcoat layer is less than the axial length of the substrate such as to create an upstream zone comprising the first washcoat layer and a downstream zone comprising the second washcoat layer, and wherein the one or more platinum group metals are at least in part contained in the second washcoat layer.

According to a fourth alternative, it is preferred that the catalyst comprises a second washcoat layer, wherein the catalyst displays a zoned arrangement of the first and second washcoat layers, wherein the second washcoat layer is provided on the substrate along its axial length starting from the inlet end of the substrate, and wherein the first washcoat layer is provided on the substrate along its axial length starting from the outlet end of the substrate, wherein the length of the second washcoat layer is less than the axial length of the substrate such as to create an upstream zone comprising the second washcoat layer and a downstream zone comprising the first washcoat layer, and wherein the one or more platinum group metals are at least in part contained in the second washcoat layer.

According to a fifth alternative, it is preferred that the catalyst comprises a second washcoat layer, wherein the catalyst displays a zoned arrangement of the first and second washcoat layers, wherein the first washcoat layer is provided on the substrate along its axial length starting from the inlet end of the substrate, and wherein the second washcoat layer is provided on the substrate along its axial length starting from the outlet end of the substrate, wherein the length of the second washcoat layer is less than the axial length of the substrate such as to create an upstream zone comprising the first washcoat layer and a downstream zone comprising the second washcoat layer, and wherein the one or more platinum group metals are at least in part contained in the second washcoat layer.

In the case where the catalyst comprises a second washcoat layer, wherein the catalyst displays a zoned arrangement of the first and second washcoat layers in accordance with the second or fourth alternative, it is preferred that the catalyst comprises a third washcoat layer, wherein the third washcoat layer is provided on the first layer, wherein the catalyst displays a zoned arrangement of the second and third washcoat layers, wherein the second washcoat layer is provided on the substrate along the axial length of the substrate starting from the inlet end of the substrate, and wherein the third washcoat layer is provided on the first washcoat layer along the axial length of the substrate starting from the outlet end of the substrate, wherein the length of the third washcoat layer is less than the axial length of the substrate such as to create an upstream zone comprising the second washcoat layer and a downstream zone comprising the first and third washcoat layers.

In the case where the catalyst comprises a second washcoat layer, wherein the catalyst displays a zoned arrangement of the first and second washcoat layers in accordance with the third or fifth alternative, it is preferred that the catalyst comprises a third washcoat layer, wherein the third washcoat layer is provided on the first layer, wherein the catalyst displays a zoned arrangement of the second and third washcoat layers, wherein the third washcoat layer is provided on the first washcoat layer along the axial length of the substrate starting from the inlet end of the substrate, and wherein the second washcoat layer is provided on the substrate along the axial length of the substrate starting from the outlet end of the substrate, wherein the length of the third washcoat layer is less than the axial length of the substrate such as to create an upstream zone comprising the first and third washcoat layers and a downstream zone comprising the second washcoat layer.

In the case where wherein the catalyst comprises a second washcoat layer, wherein the catalyst displays a zoned arrangement of the first and second washcoat layers in accordance with the second, third, fourth or fifth alternative, it is preferred that the first and second washcoat layers are adjacent to one another.

Further in the case where wherein the catalyst comprises a second washcoat layer, wherein the catalyst displays a zoned arrangement of the first and second washcoat layers in accordance with the second, third, fourth or fifth alternative, it is preferred that the second and third washcoat layers are adjacent to one another.

Further in the case where wherein the catalyst comprises a second washcoat layer, wherein the catalyst displays a zoned arrangement of the first and second washcoat layers in accordance with the second, third, fourth or fifth alternative, it is preferred that a portion of the second washcoat layer overlaps at least a portion of the first washcoat layer, wherein more preferably the second washcoat layer overlaps the first washcoat layer over a portion ranging from 10 to 100% of the axial length of the first washcoat layer, more preferably from 15 to 80%, and more preferably from 20 to 50%.

Further in the case where wherein the catalyst comprises a second washcoat layer, wherein the catalyst displays a zoned arrangement of the first and second washcoat layers in accordance with the second, third, fourth or fifth alternative, it is preferred that a portion of the first washcoat layer overlaps at least a portion of the second washcoat layer, wherein more preferably the first washcoat layer overlaps the second washcoat layer over a portion ranging from 10 to 100% of the axial length of the second washcoat layer, more preferably from 15 to 80%, and more preferably from 20 to 50%.

Further in the case where wherein the catalyst comprises a second washcoat layer, wherein the catalyst displays a zoned arrangement of the first and second washcoat layers in accordance with the second, third, fourth or fifth alternative, it is preferred that a portion of the third washcoat layer overlaps at least a portion of the first washcoat layer, wherein preferably the third washcoat layer overlaps the first washcoat layer over a portion ranging from 10 to 100% of the axial length of the first washcoat layer, more preferably from 15 to 80%, and more preferably from 20 to 50%.

According to a sixth alternative, it is preferred that the catalyst comprises a second washcoat layer, wherein the catalyst displays a zoned arrangement of the first and second washcoat layers, wherein the second washcoat layer is provided on the substrate along its entire length, and wherein the first washcoat layer is provided on the second washcoat layer along its axial length starting from the outlet end of the substrate, wherein the length of the first washcoat layer is less than the axial length of the substrate such as to create an upstream zone comprising the second washcoat layer and a downstream zone comprising the first washcoat layer over the second washcoat layer, and wherein the one or more platinum group metals are at least in part contained in the second washcoat layer.

According to a seventh alternative, it is preferred that the catalyst comprises a second washcoat layer, wherein the catalyst displays a zoned arrangement of the first and second washcoat layers, wherein the second washcoat layer is provided on the substrate along its entire length, and wherein the first washcoat layer is provided on the second washcoat layer along its axial length starting from the inlet end of the substrate, wherein the length of the first washcoat layer is less than the axial length of the substrate such as to create an upstream zone comprising the first washcoat layer over the second washcoat layer and a downstream zone comprising the second washcoat layer, and wherein the one or more platinum group metals are at least in part contained in the second washcoat layer.

In the case where the catalyst comprises a second washcoat layer, wherein the catalyst displays a zoned arrangement of the first and second washcoat layers in accordance with the sixth or seventh alternative, it is preferred that the length of the first washcoat layer ranges from 10 to 90% of the axial length of the substrate, more preferably from 30 to 80%, and more preferably from 50 to 70%.

According to an eighth alternative, it is preferred that the catalyst comprises a second washcoat layer, wherein the catalyst displays a zoned arrangement of the first and second washcoat layers, wherein the first washcoat layer is provided on the substrate along its entire length, and wherein the second washcoat layer is provided on the first washcoat layer along its axial length starting from the inlet end of the substrate, wherein the length of the second washcoat layer is less than the axial length of the substrate such as to create an upstream zone comprising the second washcoat layer over the first washcoat layer and a downstream zone comprising the first washcoat layer, and wherein the one or more platinum group metals are at least in part contained in the second washcoat layer.

In the case where the catalyst comprises a second washcoat layer, wherein the catalyst displays a zoned arrangement of the first and second washcoat layers according to the eighth alternative, it is preferred that the catalyst comprises a third washcoat layer, wherein the third washcoat layer is provided on the first layer, wherein the catalyst displays a zoned arrangement of the second and third washcoat layers, wherein the second washcoat layer is provided on the first washcoat layer along the axial length of the substrate starting from the inlet end of the substrate, and wherein the third washcoat layer is provided on the first washcoat layer along the axial length of the substrate starting from the outlet end of the substrate, wherein the length of the third washcoat layer is less than the axial length of the substrate such as to create an upstream zone comprising the second washcoat layer and a downstream zone comprising the third washcoat layer.

According to an ninth alternative, it is preferred that the catalyst comprises a second washcoat layer, wherein the catalyst displays a zoned arrangement of the first and second washcoat layers, wherein the first washcoat layer is provided on the substrate along its entire length, and wherein the second washcoat layer is provided on the first washcoat layer along its axial length starting from the outlet end of the substrate, wherein the length of the second washcoat layer is less than the axial length of the substrate such as to create an upstream zone comprising the first washcoat layer and a downstream zone comprising the second washcoat layer over the first washcoat layer, and wherein the one or more platinum group metals are at least in part contained in the second washcoat layer.

In the case where the catalyst comprises a second washcoat layer, wherein the catalyst displays a zoned arrangement of the first and second washcoat layers according to the ninth alternative, it is preferred that the catalyst comprises a third washcoat layer, wherein the third washcoat layer is provided on the first layer, wherein the catalyst displays a zoned arrangement of the second and third washcoat layers, wherein the third washcoat layer is provided on the first washcoat layer along the axial length of the substrate starting from the inlet end of the substrate, and wherein the second washcoat layer is provided on the first washcoat layer along the axial length of the substrate starting from the outlet end of the substrate, wherein the length of the third washcoat layer is less than the axial length of the substrate such as to create an upstream zone comprising the third washcoat layer and a downstream zone comprising the second washcoat layer.

In the case where the catalyst comprises a second washcoat layer, wherein the catalyst displays a zoned arrangement of the first and second washcoat layers according to the eighth or ninth alternative, and wherein the catalyst comprises a third washcoat layer, it is preferred that the second and third washcoat layers are adjacent to one another.

It is preferred that the length of the first washcoat layer ranges from 5 to 100% of the axial length of the substrate, more preferably from 10 to 90% of the axial length of the substrate, preferably from 15 to 75%, more preferably from 20 to 60%, more preferably from 25 to 50%, and more preferably from 35 to 45%.

In the case where the catalyst comprises a second washcoat layer, wherein the catalyst preferably displays a zoned arrangement of the first and second washcoat layers in accordance with the eighth or ninth alternative, it is preferred that the length of the second washcoat layer ranges from 5 to 100% of the axial length of the substrate, more preferably from 10 to 90% of the axial length of the substrate, more preferably from 15 to 75%, more preferably from 20 to 60%, more preferably from 25 to 50%, and more preferably from 35 to 45%.

In the case where the catalyst comprises second and third washcoat layers, it is preferred that the length of the third washcoat layer ranges from 5 to 100% of the axial length of the substrate, preferably from 10 to 90% of the axial length of the substrate, more preferably from 15 to 75%, more preferably from 20 to 60%, more preferably from 25 to 50%, and more preferably from 35 to 45%.

Further in the case where the catalyst comprises second and third washcoat layers, it is preferred that the third washcoat layer is substantially free of a sulfur-trap material, wherein preferably the third washcoat layer is free of a sulfur-trap material.

Further in the case where the catalyst comprises second and third washcoat layers, it is preferred that wherein the third layer comprises a hydrocarbon trap material, wherein the hydrocarbon trap material comprises a molecular sieve, preferably a zeolite, more preferably a zeolite having a maximum pore size of 12-membered rings, more preferably zeolite beta, wherein the molecular sieve, preferably the zeolite, preferably comprises SiO₂ and Al₂O₃, wherein the molecular sieve, preferably the zeolite, more preferably has a molar ratio of SiO₂ to Al₂O₃ in the range of from 10:1 to 500:1, more preferably of from 10:1 to 100:1, more preferably of from 10:1 to 40:1, more preferably of from 15:1 to 30:1, more preferably of from 20:1 to 25:1, wherein the molecular sieve, preferably the zeolite, preferably comprises Fe, wherein the molecular sieve, preferably the zeolite, more preferably comprises Fe, calculated as Fe₂O₃, in an amount in the range of from 1.0 to 7.0 weight-%, more preferably of from 3.0 to 5.0 weight-%, more preferably of from 4.0 to 4.5 weight-%, based on the weight of the molecular sieve.

In the case where the third layer comprises a hydrocarbon trap material, it is preferred that the loading of the hydrocarbon trap material in the third washcoat layer is in the range of from 0.01 to 2.0 g/in³, preferably in the range of from 0.05 to 1.0 g/in³, more preferably in the range of from 0.05 to 0.3 g/in³.

Further in the case where the catalyst comprises second and third washcoat layers, it is preferred that the one or more platinum group metals are at least in part contained in the third washcoat layer.

In the case where the one or more platinum group metals are at least in part contained in the third washcoat layer, it is preferred that the one or more platinum group metals are supported on a particulate support material, wherein the particulate support material is preferably selected from the group consisting of Al₂O₃, SiO₂, TiO₂, SiO₂-doped Al₂O₃, Mn oxide-doped Al₂O₃, and mixtures of two or more thereof, wherein preferably the one or more platinum group metals are supported on Al₂O₃ and/or SiO₂-doped Al₂O₃ and/or Mn oxide-doped Al₂O₃, more preferably SiO₂-doped Al₂O₃ or Al₂O₃ or Mn oxide-doped Al₂O₃, wherein the Mn oxide-doped Al₂O₃ preferably comprises from 1 to 10 weight-%, more preferably from 4 to 6 weight-%, of Mn oxide, calculated as MnO₂, based on 100 weight-% of the Mn oxide-doped Al₂O₃.

Further in the case where the catalyst comprises second and third washcoat layers, it is preferred that the catalyst comprises second and third washcoat layers, wherein the one or more platinum group metals are entirely contained in the second and third washcoat layers, wherein the weight ratio of the one or more platinum group metals comprised in the second washcoat layer to the one or more platinum group metals comprised in the third washcoat layer is in the range of from 0.5:1 to 5.0:1, more preferably 1.0:1 to 2.0:1, more preferably in the range of from 1.4:1 to 1.6:1, wherein the one or more platinum group metals comprised in the second washcoat layer preferably comprise, more preferably consist of, Pt and Pd, wherein the one or more platinum group metals comprised in the third washcoat layer preferably comprise, more preferably consist of, Pt and Pd.

In the case where the catalyst comprises a second washcoat layer, wherein the catalyst displays a zoned arrangement of the first and second washcoat layers in accordance with the second, third, fourth, fifth, sixth, seventh, eighth or ninth alternative, it is preferred that the loading of Mn, calculated as the element, in the zone of the catalyst containing the first washcoat layer is in the range of from 0.04 to 0.9 g/in³, based on the volume of the zone of the catalyst containing the first washcoat layer, preferably of from 0.05 to 0.8 g/in³, more preferably of from 0.15 to 0.5 g/in³, more preferably of from 0.2 to 0.35 g/in³, more preferably of from 0.23 to 0.29 g/in³, more preferably of from 0.25 to 0.27 g/in³.

In the case where the catalyst comprises a second washcoat layer, wherein the catalyst displays a zoned arrangement of the first and second washcoat layers in accordance with the first, second, third, fourth, fifth, sixth, seventh, eighth or ninth alternative, it is preferred that the one or more platinum group metals are entirely contained in the second washcoat layer or in the second and third washcoat layers.

Further in the case where the catalyst comprises a second washcoat layer, wherein the catalyst displays a zoned arrangement of the first and second washcoat layers in accordance with the first, second, third, fourth, fifth, sixth, seventh, eighth or ninth alternative, it is preferred that the one or more platinum group metals are at least in part contained in the first washcoat layer.

It is preferred that the substrate is a metallic substrate or a ceramic substrate, wherein preferably the substrate is a ceramic substrate, wherein more preferably the substrate comprises cordierite and/or SIC, preferably cordierite, wherein more preferably, the substrate consists cordierite and/or SiC, preferably of cordierite.

In the case where the catalyst comprises a second washcoat layer, wherein the catalyst displays a zoned arrangement of the first and second washcoat layers in accordance with the second, third, fourth, fifth, sixth, seventh, eighth or ninth alternative, it is preferred that the substrate consists of two separate monoliths, wherein the first monolith is provided upstream of the second monolith, wherein the washcoat layer or washcoat layers of the upstream zone are contained on the first monolith, and the washcoat layer or washcoat layers of the downstream zone are contained on the second monolith, wherein preferably the first monolith containing the washcoat layer or washcoat layers of the upstream zone and the second monolith containing the washcoat layer or washcoat layers of the downstream zone are obtained or obtainable by sectioning of a catalyst according to any one of the embodiments disclosed herein being in accordance with the second, third, fourth, fifth, sixth, seventh, eighth or ninth alternative into two separate monoliths, wherein the washcoat layer or washcoat layers of the upstream zone are contained on the first monolith, and the washcoat layer or washcoat layers of the downstream zone are contained on the second monolith.

It is preferred that the exhaust gas stream contains hydrocarbons, preferably C1 to C20 hydrocarbons, more preferably C2 to C10 hydrocarbons.

Further, the present invention relates to an exhaust gas treatment system comprising an internal combustion engine and an exhaust gas conduit for exhaust gas from the internal combustion engine, wherein the exhaust gas conduit comprises one or more catalysts according to any one of the embodiments disclosed herein, preferably one, two, three or four catalysts according to any of the embodiments disclosed herein.

It is preferred that the internal combustion engine is a compression ignition engine, more preferably a diesel engine.

It is preferred that the internal combustion engine is a lean gasoline engine.

Alternatively, it is preferred the internal combustion engine is powered by an oxygenated fuel, wherein the oxygenated fuel preferably comprises one or more of methanol and biofuel.

It is preferred that the system comprises one or more of an electric heater, a fuel burner, a fuel injector, a selective catalytic reduction (SCR) catalyst, an ammonia oxidation (AMOX) catalyst, a catalyzed soot filter (CSF), a diesel particulate filter (DPF), a selective catalytic reduction catalyst on filter (SCROF), and a diesel exotherm catalyst (DEC).

According to a first alternative, it is preferred that the system comprises in consecutive order in the direction of the exhaust gas: optionally an electric heater or a fuel burner and/or a fuel injector, a catalyst according to any of the embodiments disclosed herein, a catalyst according to any of the embodiments disclosed herein, a selective catalytic reduction (SCR) catalyst, a selective catalytic reduction (SCR) catalyst, an optional fuel injector, a diesel exotherm catalyst (DEC), a catalyzed soot filter (CSF), a selective catalytic reduction (SCR) catalyst, and a selective catalytic reduction (SCR) catalyst.

According to a second alternative, it is preferred that the system comprises in consecutive order in the direction of the exhaust gas: optionally an electric heater or a fuel burner and/or a fuel injector, a catalyst according to any of the embodiments disclosed herein, a catalyst according to any of the embodiments disclosed herein, a selective catalytic reduction (SCR) catalyst, a selective catalytic reduction (SCR) catalyst, an optional fuel injector, a diesel exotherm catalyst (DEC), a diesel particulate filter (DPF), a selective catalytic reduction (SCR) catalyst, and a selective catalytic reduction (SCR) catalyst.

According to a third alternative, it is preferred that the system comprises in consecutive order in the direction of the exhaust gas: optionally an electric heater or a fuel burner and/or a fuel injector, a catalyst according to any of the embodiments disclosed herein, a catalyst according to any of the embodiments disclosed herein, a selective catalytic reduction (SCR) catalyst, a selective catalytic reduction (SCR) catalyst, an optional fuel injector, a diesel exotherm catalyst (DEC), a diesel particulate filter (DPF), a selective catalytic reduction (SCR) catalyst, and an ammonia oxidation (AMOX) catalyst.

According to a fourth alternative, it is preferred that the system comprises in consecutive order in the direction of the exhaust gas: optionally an electric heater or a fuel burner and/or a fuel injector, a catalyst according to any of the embodiments disclosed herein, a catalyst according to any of the embodiments disclosed herein, a selective catalytic reduction (SCR) catalyst, a selective catalytic reduction (SCR) catalyst, an optional fuel injector, a catalyst according to any of the embodiments disclosed herein, a diesel particulate filter (DPF), a selective catalytic reduction (SCR) catalyst, and a selective catalytic reduction (SCR) catalyst.

According to a fifth alternative, it is preferred that the system comprises in consecutive order in the direction of the exhaust gas: optionally an electric heater or a fuel burner and/or a fuel injector, a catalyst according to any of the embodiments disclosed herein, a catalyst according to any of the embodiments disclosed herein, a selective catalytic reduction (SCR) catalyst, a selective catalytic reduction (SCR) catalyst, an optional fuel injector, a catalyst according to any of the embodiments disclosed herein, a catalyst according to any of the embodiments disclosed herein, wherein the substrate is a wall-flow substrate, a selective catalytic reduction (SCR) catalyst, and an ammonia oxidation (AMOX) catalyst.

According to a sixth alternative, it is preferred that the system comprises in consecutive order in the direction of the exhaust gas: optionally an electric heater or a fuel burner and/or a fuel injector, a catalyst according to any of the embodiments disclosed herein, a selective catalytic reduction (SCR) catalyst, a selective catalytic reduction (SCR) catalyst, a catalyzed soot filter (CSF), a selective catalytic reduction (SCR) catalyst, and a selective catalytic reduction (SCR) catalyst.

According to a seventh alternative, it is preferred that the system comprises in consecutive order in the direction of the exhaust gas: optionally an electric heater or a fuel burner and/or a fuel injector, a catalyst according to any of the embodiments disclosed herein, a selective catalytic reduction (SCR) catalyst, a selective catalytic reduction (SCR) catalyst, a catalyzed soot filter (CSF), a selective catalytic reduction (SCR) catalyst, and an ammonia oxidation (AMOX) catalyst.

According to an eighth alternative, it is preferred that the system comprises in consecutive order in the direction of the exhaust gas: optionally an electric heater or a fuel burner and/or a fuel injector, a catalyst according to any of the embodiments disclosed herein, a selective catalytic reduction (SCR) catalyst, a selective catalytic reduction (SCR) catalyst, an optional fuel injector, a catalyst according to any of the embodiments disclosed herein, wherein the substrate is a wall-flow substrate, a selective catalytic reduction (SCR) catalyst, and an ammonia oxidation (AMOX) catalyst.

According to an ninth alternative, it is preferred that the system comprises in consecutive order in the direction of the exhaust gas: optionally an electric heater or a fuel burner and/or a fuel injector, a catalyst according to any of the embodiments disclosed herein, a selective catalytic reduction (SCR) catalyst, a selective catalytic reduction catalyst on filter (SCROF), and an ammonia oxidation (AMOX) catalyst.

According to an tenth alternative, it is preferred that the system comprises in consecutive order in the direction of the exhaust gas: optionally an electric heater or a fuel burner and/or a fuel injector, a selective catalytic reduction (SCR) catalyst, an optional fuel injector, a catalyst according to any of the embodiments disclosed herein, a selective catalytic reduction catalyst on filter (SCROF), and an ammonia oxidation (AMOX) catalyst.

According to an eleventh alternative, it is preferred that the system comprises in consecutive order in the direction of the exhaust gas: optionally an electric heater or a fuel burner and/or a fuel injector, a selective catalytic reduction (SCR) catalyst, an optional fuel injector, a catalyst according to any of the embodiments disclosed herein, a catalyzed soot filter (CSF), a selective catalytic reduction (SCR) catalyst, and an ammonia oxidation (AMOX) catalyst.

According to an twelfth alternative, it is preferred that the system comprises in consecutive order in the direction of the exhaust gas: optionally an electric heater or a fuel burner and/or a fuel injector, a selective catalytic reduction (SCR) catalyst, an optional fuel injector, a catalyst according to any of the embodiments disclosed herein, a catalyst according to any of the embodiments disclosed herein, wherein the substrate is a wall-flow substrate, a selective catalytic reduction (SCR) catalyst, and an ammonia oxidation (AMOX) catalyst.

According to a thirteenth alternative, it is preferred that the system comprises in consecutive order in the direction of the exhaust gas: optionally an electric heater or a fuel burner and/or a fuel injector, a catalyst according to any of the embodiments disclosed herein, a diesel particulate filter (DPF), a selective catalytic reduction (SCR) catalyst, a selective catalytic reduction (SCR) catalyst, a selective catalytic reduction (SCR) catalyst, a selective catalytic reduction (SCR) catalyst, and an ammonia oxidation (AMOX) catalyst.

According to a fourteenth alternative, it is preferred that the system comprises in consecutive order in the direction of the exhaust gas: optionally an electric heater or a fuel burner and/or a fuel injector, a catalyst according to any of the embodiments disclosed herein, a selective catalytic reduction catalyst on filter (SCROF), a selective catalytic reduction (SCR) catalyst, and an ammonia oxidation (AMOX) catalyst.

According to a fifteenth alternative, it is preferred that the system comprises in consecutive order in the direction of the exhaust gas: optionally an electric heater or a fuel burner and/or a fuel injector, a catalyst according to any of the embodiments disclosed herein, a selective catalytic reduction (SCR) catalyst, a selective catalytic reduction catalyst on filter (SCROF), a selective catalytic reduction (SCR) catalyst, and an ammonia oxidation (AMOX) catalyst.

Yet further, the present invention relates to a method for the treatment of an exhaust gas stream containing one or more of formaldehyde, nitrogen oxide (NO), and one or more hydrocarbons, the method comprising
(A) providing an exhaust gas stream comprising one or more of formaldehyde, nitrogen oxide (NO), and one or more hydrocarbons;
(B) directing the exhaust gas stream provided in (A) through a catalyst according to any one of the embodiments disclosed herein.

It is preferred that the exhaust gas stream provided in (A) comprises one or more sulfur-containing compounds, more preferably SO₂ and/or SO₃.

It is preferred that the exhaust gas stream provided in (A) comprises NOx.

It is preferred that the exhaust gas stream provided in (A) comprises CO.

It is preferred that the exhaust gas stream provided in (A) comprises formaldehyde.

It is preferred that the exhaust gas stream provided in (A) comprises nitrogen oxide (NO).

It is preferred that the exhaust gas stream provided in (A) comprises hydrocarbons, preferably C1 to C20 hydrocarbons, more preferably C2 to C10 hydrocarbons.

Yet further, the present invention relates to a use of a catalyst according to any one of the embodiments disclosed herein for the oxidation of one or more of formaldehyde, nitrogen oxide (NO), and hydrocarbons, more preferably for the oxidation of one or more of formaldehyde, nitrogen oxide (NO), and hydrocarbons in an exhaust gas stream, more preferably for the oxidation of one or more of formaldehyde, nitrogen oxide (NO), and hydrocarbons in the exhaust gas stream of an internal combustion engine, more preferably for the oxidation of one or more of formaldehyde, nitrogen oxide (NO), and hydrocarbons in the exhaust gas stream of a compression ignition engine, more preferably for the oxidation of one or more of formaldehyde, nitrogen oxide (NO), and hydrocarbons in the exhaust gas stream of a diesel engine.

The present invention is further illustrated by the following set of embodiments and combinations of embodiments resulting from the dependencies and back-references as indicated. In particular, it is noted that in each instance where a range of embodiments is mentioned, for example in the context of a term such as “The catalyst of any one of embodiments 1 to 4”, every embodiment in this range is meant to be explicitly disclosed for the skilled person, i.e. the wording of this term is to be understood by the skilled person as being synonymous to “The catalyst of any one of embodiments 1, 2, 3, and 4”. Further, it is explicitly noted that the following set of embodiments represents a suitably structured part of the general description directed to preferred aspects of the present invention, and, thus, suitably supports, but does not represent the claims of the present invention.
1. A catalyst for the treatment of an exhaust gas stream containing one or more of formaldehyde, nitrogen oxide (NO), and hydrocarbons, the catalyst comprising
   a first washcoat layer comprising Mn, and
   a substrate,
wherein the substrate has an inlet end through which the exhaust gas stream may enter the catalyst, and an outlet end through which the exhaust gas stream may exit the catalyst,
wherein the catalyst further comprises one or more platinum group metals comprising Pt, Pd, or Pt and Pd, wherein the one or more platinum group metals are at least in part contained in one or more of:
   (a) the first washcoat layer, and
   (b) an optional second washcoat layer, or
   (c) optional second and third washcoat layers,
wherein the loading of Mn in the catalyst, calculated as the element, is in the range of from 0.04 to 0.9 g/in³, preferably of from 0.05 to 0.8 g/in³, more preferably of from 0.06 to 0.7 g/in³, more preferably of from 0.07 to 0.6 g/in³, more preferably of from 0.08 to 0.5 g/in³, more preferably of from 0.1 to 0.25 g/in³, more preferably of from 0.12 to 0.22 g/in³, more preferably of from 0.14 to 0.2 g/in³, more preferably of from 0.16 to 0.18 g/in³.
2. The catalyst of embodiment 1, wherein the optional second washcoat layer is substantially free of Mn, wherein preferably the optional second washcoat layer is free of Mn.
3. The catalyst of embodiment 1 or 2, wherein the loading of Mn, calculated as the element, in the first washcoat layer is in the range of from 1 to 50 wt.-% based on 100 wt.-% of the first washcoat layer, preferably from 2 to 30 wt.-%, more preferably from 5 to 20 wt.-%, more preferably from 8 to 12 wt.-%.
4. The catalyst of any of embodiments 1 to 3, wherein Mn is present in the form of one or more cations of Mn, wherein Mn is preferably contained in the first washcoat layer as one or more oxides, wherein Mn is more preferably contained in the first washcoat layer as one or more oxides of Mn(II), Mn(III), Mn(II/III), and Mn(IV), more preferably as one or more oxides selected from the group consisting of MnO, Mn₂O₃, Mn₃O₄, MnO₂, and Mn(O)OH, and Mn—Zr mixed oxides, including mixtures of two or more thereof, wherein the Mn—Zr mixed oxides are preferably contained in the first washcoat layer as a solid solution.
5. The catalyst of any of embodiments 1 to 4, wherein the first washcoat layer comprises a particulate support material, wherein Mn is supported on the particulate support material, wherein the particulate support material is preferably selected from the group consisting of ZrO₂, Al₂O₃, SiO₂, TiO₂, La₂O₃-doped ZrO₂, CeO₂—ZrO₂ mixed oxide, La₂O₃-doped CeO₂—ZrO₂ mixed oxide, Nd₂O₃-doped CeO₂—ZrO₂ mixed oxide, Y₂O₃-doped CeO₂—ZrO₂ mixed oxide, praseodymium oxide-doped CeO₂—ZrO₂ mixed oxide ZrO₂-doped Al₂O₃, ZrO₂-doped SiO₂, SiO₂-doped Al₂O₃, CuO—Al₂O₃ mixed oxide, and mixtures of two or more thereof, more preferably from the group consisting of ZrO₂, La₂O₃-doped ZrO₂, CeO₂—ZrO₂ mixed oxide, La₂O₃-doped CeO₂—ZrO₂ mixed oxide, Nd₂O₃-doped CeO₂—ZrO₂ mixed oxide, Y₂O₃-doped CeO₂—ZrO₂ mixed oxide, Pr₂O₃-doped CeO₂—ZrO₂ mixed oxide, Pr₆O₁₁-doped CeO₂—ZrO₂ mixed oxide, PrO₂-doped CeO₂—ZrO₂ mixed oxide, ZrO₂-doped Al₂O₃, ZrO₂-doped SiO₂, and mixtures of two or more thereof, more preferably from the group consisting of ZrO₂, La₂O₃-doped ZrO₂, CeO₂—ZrO₂ mixed oxide, La₂O₃-doped CeO₂—ZrO₂ mixed oxide, Nd₂O₃-doped CeO₂—ZrO₂ mixed oxide, Y₂O₃-doped CeO₂—ZrO₂ mixed oxide, Pr₂O₃-doped CeO₂—ZrO₂ mixed oxide, PreO₁₁-doped CeO₂—ZrO₂ mixed oxide, and mixtures of two or more thereof, wherein more preferably Mn is supported on particulate La₂O₃-doped ZrO₂, wherein preferably ZrO₂ is doped with La₂O₃ in an amount ranging from 1 to 50 wt. % based on 100 wt.-% of ZrO₂ and La₂O₃, preferably from 3 to 30 wt.-%, more preferably from 5 to 15 wt.-%, more preferably from 8 to 10 wt.-%.
6. The catalyst of any of embodiments 1 to 5, wherein the first washcoat layer comprises Ce, wherein Ce is preferably contained in the first washcoat layer as CeO₂ and/or Ce₂O₃.
7. The catalyst of embodiment 6, wherein the loading of Ce, calculated as the element, in the first washcoat layer is in the range of from 1 to 50 wt.-% based on 100 wt.-% of the first washcoat layer, preferably from 2 to 30 wt.-%, more preferably from 5 to 20 wt.-%, more preferably from 8 to 12 wt.-%.
8. The catalyst of embodiment 6 or 7, wherein Ce is supported on a particulate support material, wherein the particulate support material is preferably selected from the group consisting of ZrO₂, Al₂O₃, SiO₂, TiO₂, La₂O₃-doped ZrO₂, CeO₂—ZrO₂ mixed oxide, La₂O₃-doped CeO₂—ZrO₂ mixed oxide, Nd₂O₃-doped CeO₂—ZrO₂ mixed oxide, Y₂O₃-doped CeO₂—ZrO₂ mixed oxide, praseodymium oxide-doped CeO₂—ZrO₂ mixed oxide, ZrO₂-doped Al₂O₃, ZrO₂-doped SiO₂, SiO₂-doped Al₂O₃, CuO—Al₂O₃ mixed oxide, and mixtures of two or more thereof, more preferably from the group consisting of ZrO₂, La₂O₃-doped ZrO₂, CeO₂—ZrO₂ mixed oxide, La₂O₃-doped CeO₂—ZrO₂ mixed oxide, Nd₂O₃-doped CeO₂—ZrO₂ mixed oxide, Y₂O₃-doped CeO₂—ZrO₂ mixed oxide, Pr₂O₃-doped CeO₂—ZrO₂ mixed oxide, Pr₆O₁₁-doped CeO₂—ZrO₂ mixed oxide, PrO₂-doped CeO₂—ZrO₂ mixed oxide, ZrO₂-doped Al₂O₃, ZrO₂-doped SiO₂, and mixtures of two or more thereof, more preferably from the group consisting of ZrO₂, La₂O₃-doped ZrO₂, CeO₂—ZrO₂ mixed oxide, La₂O₃-doped CeO₂—ZrO₂ mixed oxide, Nd₂O₃-doped CeO₂—ZrO₂ mixed oxide, Y₂O₃-doped CeO₂—ZrO₂ mixed oxide, Pr₂O₃-doped CeO₂—ZrO₂ mixed oxide, PreO₁₁-doped CeO₂—ZrO₂ mixed oxide, and mixtures of two or more thereof, wherein more preferably Ce is supported on particulate La₂O₃-doped ZrO₂, wherein preferably ZrO₂ is doped with La₂O₃ in an amount ranging from 1 to 50 wt. % based on 100 wt.-% of ZrO₂ and La₂O₃, preferably from 3 to 30 wt.-%, more preferably from 5 to 15 wt.-%, more preferably from 8 to 10 wt.-%.
9. The catalyst of any of embodiments 1 to 5, wherein the first washcoat layer is substantially free of Ce, wherein preferably the first washcoat layer is free of Ce.
10. The catalyst of embodiment 9, wherein the catalyst is substantially free of Ce, wherein preferably the catalyst is free of Ce.
11. The catalyst of any of embodiments 1 to 10, wherein the first washcoat layer comprises Cu, wherein the first washcoat layer preferably comprises CuO, Cu₂O, or CuO and Cu₂O, more preferably CuO.
12. The catalyst of embodiment 11, wherein the loading of Cu, calculated as the element, in the first washcoat layer is in the range of from 1 to 50 wt.-% based on 100 wt.-% of the first washcoat layer, preferably from 2 to 30 wt.-%, more preferably from 5 to 20 wt.-%, more preferably from 8 to 12 wt.-%.
13. The catalyst of embodiment 11 or 12, wherein Cu is supported on a particulate support material, wherein the particulate support material is preferably selected from the group consisting of ZrO₂, Al₂O₃, SiO₂, TiO₂, La₂O₃-doped ZrO₂, CeO₂—ZrO₂ mixed oxide, La₂O₃-doped CeO₂—ZrO₂ mixed oxide, Nd₂O₃-doped CeO₂—ZrO₂ mixed oxide, Y₂O₃-doped CeO₂—ZrO₂ mixed oxide, praseodymium oxide-doped CeO₂—ZrO₂ mixed oxide ZrO₂-doped Al₂O₃, ZrO₂-doped SiO₂, SiO₂-doped Al₂O₃, CuO—Al₂O₃ mixed oxide, and mixtures of two or more thereof, more preferably from the group consisting of ZrO₂, La₂O₃-doped ZrO₂, CeO₂—ZrO₂ mixed oxide, La₂O₃-doped CeO₂—ZrO₂ mixed oxide, Nd₂O₃-doped CeO₂—ZrO₂ mixed oxide, Y₂O₃-doped CeO₂—ZrO₂ mixed oxide, Pr₂O₃-doped CeO₂—ZrO₂ mixed oxide, Pr₆O₁₁-doped CeO₂—ZrO₂ mixed oxide, PrO₂-doped CeO₂—ZrO₂ mixed oxide, ZrO₂-doped Al₂O₃, ZrO₂-doped SiO₂, and mixtures of two or more thereof, more preferably from the group consisting of ZrO₂, La₂O₃-doped ZrO₂, CeO₂—ZrO₂ mixed oxide, La₂O₃-doped CeO₂—ZrO₂ mixed oxide, Nd₂O₃-doped CeO₂—ZrO₂ mixed oxide, Y₂O₃-doped CeO₂—ZrO₂ mixed oxide, Pr₂O₃-doped CeO₂—ZrO₂ mixed oxide, Pr₆O₁₁-doped CeO₂—ZrO₂ mixed oxide, and mixtures of two or more thereof, wherein more preferably Cu is supported on particulate La₂O₃-doped ZrO₂, wherein preferably ZrO₂ is doped with La₂O₃ in an amount ranging from 1 to 50 wt. % based on 100 wt.-% of ZrO₂ and La₂O₃, preferably from 3 to 30 wt.-%, more preferably from 5 to 15 wt.-%, more preferably from 8 to 10 wt.-%.
14. The catalyst of any of embodiments 1 to 10, wherein the first washcoat layer is substantially free of Cu, wherein preferably the first washcoat layer is free of Cu.
15. The catalyst of embodiment 14, wherein the catalyst is substantially free of Cu, wherein preferably the catalyst is free of Cu.
16. The catalyst of any of embodiments 1 to 15, wherein the substrate is a wall-flow substrate or a flow-through substrate, preferably a honeycomb wall-flow substrate or a honeycomb flow-through substrate, more preferably a honeycomb flow-through substrate, wherein the flow-through substrate is more preferably a flow-through substrate with high porosity walls.
17. The catalyst of any of embodiments 1 to 16, wherein the loading of the first washcoat layer is in the range of from 0.3 to 6 g/in³, preferably of from 1 to 5 g/in³, more preferably of from 1.5 to 4 g/in³, more preferably of from 2 to 3.5 g/in³, more preferably of from 2.3 to 2.9 g/in³, more preferably of from 2.5 to 2.7 g/in³.
18. The catalyst of any of embodiments 1 to 17, wherein the loading of the second washcoat layer is in the range of from 0.25 to 6 g/in³, preferably of from 0.3 to 6 g/in³, more preferably of from 1 to 5 g/in³, more preferably of from 1.5 to 4 g/in³, more preferably of from 2 to 3.5 g/in³, more preferably of from 2.2 to 3.0 g/in³, more preferably of from 2.3 to 2.9 g/in³, more preferably of from 2.5 to 2.7 g/in³.
19. The catalyst of any of embodiments 1 to 18, wherein the catalyst comprises one or more platinum group metals consisting of Pt, Pd, or Pt and Pd, wherein preferably the catalyst comprises Pt, or Pt and Pd as the one or more platinum group metals, wherein more preferably the catalyst comprises Pt and Pd as the one or more platinum group metals.
20. The catalyst of any of embodiments 1 to 19, wherein the catalyst comprises Pt, calculated as the element, at a loading in the range of from 2 to 250 g/ft³, preferably of from 5 to 150 g/ft³, more preferably of from 10 to 125 g/ft³, more preferably of from 20 to 100 g/ft³, more preferably of from 25 to 85 g/ft³, more preferably of from 30 to 80 g/ft³, more preferably of from 40 to 60 g/ft³.
21. The catalyst of any of embodiments 1 to 20, wherein the catalyst comprises Pd, calculated as the element, at a loading in the range of from 5 to 100 g/ft³, preferably of from 5 to 60 g/ft³, more preferably of from 10 to 50 g/ft³, more preferably of from 15 to 40 g/ft³, more preferably of from 20 to 30 g/ft³.
22. The catalyst of any of embodiments 1 to 21, wherein the catalyst comprises Pt and Pd, calculated as the respective element, at a total Pt and Pd loading in the range of from 2 to 250 g/ft³, preferably of from 5 to 200 g/ft³, more preferably of from 10 to 150 g/ft³, more preferably of from 20 to 130 g/ft³, more preferably of from 30 to 125 g/ft³, more preferably of from 40 to 110 g/ft³, more preferably of from 50 to 100 g/ft³, more preferably of from 60 to 90 g/ft³, more preferably of from 70 to 80 g/ft³.
23. The catalyst of any of embodiments 1 to 22, wherein the catalyst comprises Pt and Pd at a Pt:Pd weight ratio in the range of from 1:2 to 20:1, preferably of from 50:50 to 80:20, more preferably of from 60:40 to 75:25, more preferably of from 65:35 to 70:30.
24. The catalyst of any of embodiments 1 to 23, wherein the one or more platinum group metals are supported on a particulate support material, wherein the particulate support material is preferably selected from the group consisting of Al₂O₃, SiO₂, TiO₂, SiO₂-doped Al₂O₃, Mn oxide-doped Al₂O₃, and mixtures of two or more thereof, wherein preferably the one or more platinum group metals are supported on Al₂O₃ and/or SiO₂-doped Al₂O₃ and/or Mn oxide-doped Al₂O₃, more preferably SiO₂-doped Al₂O₃ or Al₂O₃ or Mn oxide-doped Al₂O₃, wherein the Mn oxide-doped Al₂O₃ preferably comprises from 1 to 10 weight-%, more preferably from 4 to 6 weight-%, of Mn oxide, calculated as Mn oxide, based on 100 weight-% of the Mn oxide-doped Al₂O₃.
25. The catalyst of any of embodiments 1 to 24, wherein the first washcoat layer comprises a hydrocarbon trap material, wherein the hydrocarbon trap material comprises a molecular sieve, preferably a zeolite, more preferably a zeolite having a maximum pore size of 12-membered rings, more preferably zeolite beta, wherein the molecular sieve, preferably the zeolite, preferably comprises SiO₂ and Al₂O₃, wherein the molecular sieve, preferably the zeolite, more preferably has a molar ratio of SiO₂ to Al₂O₃ in the range of from 10:1 to 500:1, more preferably of from 10:1 to 100:1, more preferably of from 10:1 to 40:1, more preferably of from 15:1 to 30:1, more preferably of from 20:1 to 25:1, wherein the molecular sieve, preferably the zeolite, preferably comprises Fe, wherein the molecular sieve, preferably the zeolite, more preferably comprises Fe, calculated as Fe₂O₃, in an amount in the range of from 1.0 to 7.0 weight-%, more preferably of from 3.0 to 5.0 weight-%, more preferably of from 4.0 to 4.5 weight-%, based on the weight of the molecular sieve.
26. The catalyst of embodiment 25, wherein the loading of the hydrocarbon trap material in the first washcoat layer is in the range of from 0.01 to 2.0 g/in³, preferably in the range of from 0.05 to 1.0 g/in³, more preferably in the range of from 0.05 to 0.3 g/in³.
27. The catalyst of any of embodiments 1 to 26, wherein the catalyst comprises a second washcoat layer, wherein the one or more platinum group metals are at least in part contained in the second washcoat layer, wherein preferably the one or more platinum group metals are entirely contained in the second washcoat layer.
28. The catalyst of any of embodiments 1 to 27, wherein the second washcoat layer comprises a hydrocarbon trap material, wherein the hydrocarbon trap material comprises a molecular sieve, preferably a zeolite, more preferably a zeolite having a maximum pore size defined by 12-membered rings, more preferably zeolite beta, wherein the molecular sieve, preferably the zeolite, preferably comprises SiO₂ and Al₂O₃, wherein the molecular sieve, preferably the zeolite, more preferably has a molar ratio of SiO₂ to Al₂O₃ in the range of from 10:1 to 40:1, more preferably of from 15:1 to 30:1, more preferably of from 20:1 to 25:1, wherein the molecular sieve, preferably the zeolite, preferably comprises Fe, wherein the molecular sieve, preferably the zeolite, more preferably comprises Fe, calculated as Fe₂O₃, in an amount in the range of from 1.0 to 7.0 weight-%, more preferably of from 3.0 to 5.0 weight-%, more preferably of from 4.0 to 4.5 weight-%, based on the weight of the molecular sieve.
29. The catalyst of embodiment 28, wherein the loading of the hydrocarbon trap material in the second washcoat layer is in the range of from 0.01 to 2.0 g/in³, preferably in the range of from 0.05 to 1.0 g/in³ g/in³, more preferably in the range of from 0.05 to 0.3 g/in³.
30. The catalyst of any of embodiments 1 to 29, wherein the catalyst comprises a second washcoat layer, wherein the catalyst displays a layered arrangement of the first and second washcoat layers, and wherein the one or more platinum group metals are at least in part contained in the second washcoat layer.
31. The catalyst of embodiment 30, wherein the first washcoat layer is provided on the substrate, and the second washcoat layer is provided on the first washcoat layer.
32. The catalyst of embodiment 30 or 31, wherein the second washcoat layer is provided on the substrate, and the first washcoat layer is provided on the second washcoat layer.
33. The catalyst of embodiment 30 or 31, wherein the catalyst comprises a third washcoat layer, wherein the catalyst displays a zoned arrangement of the first, second, and third washcoat layers, wherein the third washcoat layer is provided on the substrate along its axial length starting from the inlet end of the substrate and wherein the first washcoat layer is provided on the substrate along its axial length starting from the outlet end of the substrate, and wherein the second washcoat layer is provided on and entirely covers the first washcoat layer, wherein the length of the first washcoat layer is less than the axial length of the substrate such as to create an upstream zone comprising the third washcoat layer and a downstream zone comprising the first and second washcoat layers, and wherein the one or more platinum group metals are at least in part contained in the third washcoat layer.
34. The catalyst of embodiment 30 or 32, wherein the catalyst comprises a third washcoat layer, wherein the catalyst displays a zoned arrangement of the first, second, and third washcoat layers, wherein the third washcoat layer is provided on the substrate along its axial length starting from the inlet end of the substrate and wherein the second washcoat layer is provided on the substrate along its axial length starting from the outlet end of the substrate, and wherein the first washcoat layer is provided on and entirely covers the second washcoat layer, wherein the length of the second washcoat layer is less than the axial length of the substrate such as to create an upstream zone comprising the third washcoat layer and a downstream zone comprising the first and second washcoat layers, and wherein the one or more platinum group metals are at least in part contained in the third washcoat layer.
35. The catalyst of embodiment 30 or 31, wherein the catalyst comprises a third washcoat layer, wherein the catalyst displays a zoned arrangement of the first, second, and third washcoat layers, wherein the third washcoat layer is provided on the substrate along its axial length starting from the outlet end of the substrate and wherein the first washcoat layer is provided on the substrate along its axial length starting from the inlet end of the substrate, and wherein the second washcoat layer is provided on and entirely covers the first washcoat layer, wherein the length of the first washcoat layer is less than the axial length of the substrate such as to create a downstream zone comprising the third washcoat layer and an upstream zone comprising the first and second washcoat layers, and wherein the one or more platinum group metals are at least in part contained in the third washcoat layer.
36. The catalyst of embodiment 30 or 32, wherein the catalyst comprises a third washcoat layer, wherein the catalyst displays a zoned arrangement of the first, second, and third washcoat layers, wherein the third washcoat layer is provided on the substrate along its axial length starting from the outlet end of the substrate and wherein the second washcoat layer is provided on the substrate along its axial length starting from the inlet end of the substrate, and wherein the first washcoat layer is provided on and entirely covers the second washcoat layer, wherein the length of the second washcoat layer is less than the axial length of the substrate such as to create a downstream zone comprising the third washcoat layer and an upstream zone comprising the first and second washcoat layers, and wherein the one or more platinum group metals are at least in part contained in the third washcoat layer.
37. The catalyst of any of embodiments 1 to 29, wherein the catalyst comprises a second washcoat layer, wherein the catalyst displays a zoned arrangement of the first and second washcoat layers, wherein the second washcoat layer is provided on the substrate along its axial length starting from the inlet end of the substrate, and wherein the first washcoat layer is provided on the substrate along its axial length starting from the outlet end of the substrate, wherein the length of the first washcoat layer is less than the axial length of the substrate such as to create an upstream zone comprising the second washcoat layer and a downstream zone comprising the first washcoat layer, and wherein the one or more platinum group metals are at least in part contained in the second washcoat layer.
38. The catalyst of any of embodiments 1 to 29, wherein the catalyst comprises a second washcoat layer, wherein the catalyst displays a zoned arrangement of the first and second washcoat layers, wherein the first washcoat layer is provided on the substrate along its axial length starting from the inlet end of the substrate, and wherein the second washcoat layer is provided on the substrate along its axial length starting from the outlet end of the substrate, wherein the length of the first washcoat layer is less than the axial length of the substrate such as to create an upstream zone comprising the first washcoat layer and a downstream zone comprising the second washcoat layer, and wherein the one or more platinum group metals are at least in part contained in the second washcoat layer.
39. The catalyst of any of embodiments 1 to 29, wherein the catalyst comprises a second washcoat layer, wherein the catalyst displays a zoned arrangement of the first and second washcoat layers, wherein the second washcoat layer is provided on the substrate along its axial length starting from the inlet end of the substrate, and wherein the first washcoat layer is provided on the substrate along its axial length starting from the outlet end of the substrate, wherein the length of the second washcoat layer is less than the axial length of the substrate such as to create an upstream zone comprising the second washcoat layer and a downstream zone comprising the first washcoat layer, and wherein the one or more platinum group metals are at least in part contained in the second washcoat layer.
40. The catalyst of any of embodiments 1 to 29, wherein the catalyst comprises a second washcoat layer, wherein the catalyst displays a zoned arrangement of the first and second washcoat layers, wherein the first washcoat layer is provided on the substrate along its axial length starting from the inlet end of the substrate, and wherein the second washcoat layer is provided on the substrate along its axial length starting from the outlet end of the substrate, wherein the length of the second washcoat layer is less than the axial length of the substrate such as to create an upstream zone comprising the first washcoat layer and a downstream zone comprising the second washcoat layer, and wherein the one or more platinum group metals are at least in part contained in the second washcoat layer.
41. The catalyst of embodiment 37 or 39, wherein the catalyst comprises a third washcoat layer, wherein the third washcoat layer is provided on the first layer, wherein the catalyst displays a zoned arrangement of the second and third washcoat layers, wherein the second washcoat layer is provided on the substrate along the axial length of the substrate starting from the inlet end of the substrate, and wherein the third washcoat layer is provided on the first washcoat layer along the axial length of the substrate starting from the outlet end of the substrate, wherein the length of the third washcoat layer is less than the axial length of the substrate such as to create an upstream zone comprising the second washcoat layer and a downstream zone comprising the first and third washcoat layers.
42. The catalyst of embodiment 38 or 40, wherein the catalyst comprises a third washcoat layer, wherein the third washcoat layer is provided on the first layer, wherein the catalyst displays a zoned arrangement of the second and third washcoat layers, wherein the third washcoat layer is provided on the first washcoat layer along the axial length of the substrate starting from the inlet end of the substrate, and wherein the second washcoat layer is provided on the substrate along the axial length of the substrate starting from the outlet end of the substrate, wherein the length of the third washcoat layer is less than the axial length of the substrate such as to create an upstream zone comprising the first and third washcoat layers and a downstream zone comprising the second washcoat layer.
43. The catalyst of any of embodiments 33 to 42, wherein the first and second washcoat layers are adjacent to one another.
44. The catalyst of embodiment 33 to 43, wherein the second and third washcoat layers are adjacent to one another.
45. The catalyst of any of embodiments 33 to 44, wherein a portion of the second washcoat layer overlaps at least a portion of the first washcoat layer, wherein preferably the second washcoat layer overlaps the first washcoat layer over a portion ranging from 10 to 100% of the axial length of the first washcoat layer, more preferably from 15 to 80%, and more preferably from 20 to 50%.
46. The catalyst of any of embodiments 33 to 45, wherein a portion of the first washcoat layer overlaps at least a portion of the second washcoat layer, wherein preferably the first washcoat layer overlaps the second washcoat layer over a portion ranging from 10 to 100% of the axial length of the second washcoat layer, more preferably from 15 to 80%, and more preferably from 20 to 50%.
47. The catalyst of any of embodiments 33 to 46, wherein a portion of the third washcoat layer overlaps at least a portion of the first washcoat layer, wherein preferably the third washcoat layer overlaps the first washcoat layer over a portion ranging from 10 to 100% of the axial length of the first washcoat layer, more preferably from 15 to 80%, and more preferably from 20 to 50%.
48. The catalyst of any of embodiments 1 to 29, wherein the catalyst comprises a second washcoat layer, wherein the catalyst displays a zoned arrangement of the first and second washcoat layers, wherein the second washcoat layer is provided on the substrate along its entire length, and wherein the first washcoat layer is provided on the second washcoat layer along its axial length starting from the outlet end of the substrate, wherein the length of the first washcoat layer is less than the axial length of the substrate such as to create an upstream zone comprising the second washcoat layer and a downstream zone comprising the first washcoat layer over the second washcoat layer, and wherein the one or more platinum group metals are at least in part contained in the second washcoat layer.
49. The catalyst of any of embodiments 1 to 29, wherein the catalyst comprises a second washcoat layer, wherein the catalyst displays a zoned arrangement of the first and second washcoat layers, wherein the second washcoat layer is provided on the substrate along its entire length, and wherein the first washcoat layer is provided on the second washcoat layer along its axial length starting from the inlet end of the substrate, wherein the length of the first washcoat layer is less than the axial length of the substrate such as to create an upstream zone comprising the first washcoat layer over the second washcoat layer and a downstream zone comprising the second washcoat layer, and wherein the one or more platinum group metals are at least in part contained in the second washcoat layer.
50. The catalyst of embodiment 48 or 49, wherein the length of the first washcoat layer ranges from 10 to 90% of the axial length of the substrate, preferably from 30 to 80%, and more preferably from 50 to 70%.
51. The catalyst of any of embodiments 1 to 29, wherein the catalyst comprises a second washcoat layer, wherein the catalyst displays a zoned arrangement of the first and second washcoat layers, wherein the first washcoat layer is provided on the substrate along its entire length, and wherein the second washcoat layer is provided on the first washcoat layer along its axial length starting from the inlet end of the substrate, wherein the length of the second washcoat layer is less than the axial length of the substrate such as to create an upstream zone comprising the second washcoat layer over the first washcoat layer and a downstream zone comprising the first washcoat layer, and wherein the one or more platinum group metals are at least in part contained in the second washcoat layer.
52. The catalyst of embodiment 51, wherein the catalyst comprises a third washcoat layer, wherein the third washcoat layer is provided on the first layer, wherein the catalyst displays a zoned arrangement of the second and third washcoat layers, wherein the second washcoat layer is provided on the first washcoat layer along the axial length of the substrate starting from the inlet end of the substrate, and wherein the third washcoat layer is provided on the first washcoat layer along the axial length of the substrate starting from the outlet end of the substrate, wherein the length of the third washcoat layer is less than the axial length of the substrate such as to create an upstream zone comprising the second washcoat layer and a downstream zone comprising the third washcoat layer.
53. The catalyst of any of embodiments 1 to 29, wherein the catalyst comprises a second washcoat layer, wherein the catalyst displays a zoned arrangement of the first and second washcoat layers, wherein the first washcoat layer is provided on the substrate along its entire length, and wherein the second washcoat layer is provided on the first washcoat layer along its axial length starting from the outlet end of the substrate, wherein the length of the second washcoat layer is less than the axial length of the substrate such as to create an upstream zone comprising the first washcoat layer and a downstream zone comprising the second washcoat layer over the first washcoat layer, and wherein the one or more platinum group metals are at least in part contained in the second washcoat layer.
54. The catalyst of embodiment 53, wherein the catalyst comprises a third washcoat layer, wherein the third washcoat layer is provided on the first layer, wherein the catalyst displays a zoned arrangement of the second and third washcoat layers, wherein the third washcoat layer is provided on the first washcoat layer along the axial length of the substrate starting from the inlet end of the substrate, and wherein the second washcoat layer is provided on the first washcoat layer along the axial length of the substrate starting from the outlet end of the substrate, wherein the length of the third washcoat layer is less than the axial length of the substrate such as to create an upstream zone comprising the third washcoat layer and a downstream zone comprising the second washcoat layer.
55. The catalyst of embodiment 52 or 54, wherein the second and third washcoat layers are adjacent to one another.
56. The catalyst of embodiment 1 to 55, wherein the length of the first washcoat layer ranges from 5 to 100% of the axial length of the substrate, preferably from 10 to 90% of the axial length of the substrate, preferably from 15 to 75%, more preferably from 20 to 60%, more preferably from 25 to 50%, and more preferably from 35 to 45%.
57. The catalyst of embodiment 30 to 56, wherein the length of the second washcoat layer ranges from 5 to 100% of the axial length of the substrate, preferably from 10 to 90% of the axial length of the substrate, more preferably from 15 to 75%, more preferably from 20 to 60%, more preferably from 25 to 50%, and more preferably from 35 to 45%.
58. The catalyst of embodiment 33 to 57, wherein the length of the third washcoat layer ranges from 5 to 100% of the axial length of the substrate, preferably from 10 to 90% of the axial length of the substrate, preferably from 15 to 75%, more preferably from 20 to 60%, more preferably from 25 to 50%, and more preferably from 35 to 45%.
59. The catalyst of any of embodiments 33 to 58, wherein the third washcoat layer is substantially free of a sulfur-trap material, wherein preferably the third washcoat layer is free of a sulfur-trap material.
60. The catalyst of any of embodiments 33 to 59, wherein the third layer comprises a hydrocarbon trap material, wherein the hydrocarbon trap material comprises a molecular sieve, preferably a zeolite, more preferably a zeolite having a maximum pore size of 12-membered rings, more preferably zeolite beta, wherein the molecular sieve, preferably the zeolite, preferably comprises SiO₂ and Al₂O₃, wherein the molecular sieve, preferably the zeolite, more preferably has a molar ratio of SiO₂ to Al₂O₃ in the range of from 10:1 to 500:1, more preferably of from 10:1 to 100:1, more preferably of from 10:1 to 40:1, more preferably of from 15:1 to 30:1, more preferably of from 20:1 to 25:1, wherein the molecular sieve, preferably the zeolite, preferably comprises Fe, wherein the molecular sieve, preferably the zeolite, more preferably comprises Fe, calculated as Fe₂O₃, in an amount in the range of from 1.0 to 7.0 weight-%, more preferably of from 3.0 to 5.0 weight-%, more preferably of from 4.0 to 4.5 weight-%, based on the weight of the molecular sieve.
61. The catalyst of embodiment 60, wherein the loading of the hydrocarbon trap material in the third washcoat layer is in the range of from 0.01 to 2.0 g/in³, preferably in the range of from 0.05 to 1.0 g/in³, more preferably in the range of from 0.05 to 0.3 g/in³.
62. The catalyst of any of embodiments 33 to 61, wherein the one or more platinum group metals are at least in part contained in the third washcoat layer.
63. The catalyst of embodiment 62, wherein the one or more platinum group metals are supported on a particulate support material, wherein the particulate support material is preferably selected from the group consisting of Al₂O₃, SiO₂, TiO₂, SiO₂-doped Al₂O³, Mn oxide-doped Al₂O₃, and mixtures of two or more thereof, wherein preferably the one or more platinum group metals are supported on Al₂O₃ and/or SiO₂-doped Al₂O₃ and/or Mn oxide-doped Al₂O₃, more preferably SiO₂-doped Al₂O₃ or Al₂O₃ or Mn oxide-doped Al₂O₃, wherein the Mn oxide-doped Al₂O₃ preferably comprises from 1 to 10 weight-%, more preferably from 4 to 6 weight-%, of Mn oxide, calculated as MnO₂, based on 100 weight-% of the Mn oxide-doped Al₂O₃.
64. The catalyst of any of embodiments 33 to 63, wherein the catalyst comprises second and third washcoat layers, wherein the one or more platinum group metals are entirely contained in the second and third washcoat layers, wherein the weight ratio of the one or more platinum group metals comprised in the second washcoat layer to the one or more platinum group metals comprised in the third washcoat layer is in the range of from 0.5:1 to 5.0:1, more preferably 1.0:1 to 2.0:1, more preferably in the range of from 1.4:1 to 1.6:1, wherein the one or more platinum group metals comprised in the second washcoat layer preferably comprise, more preferably consist of, Pt and Pd, wherein the one or more platinum group metals comprised in the third washcoat layer preferably comprise, more preferably consist of, Pt and Pd.
65. The catalyst of any of embodiments 33 to 64, wherein the loading of Mn, calculated as the element, in the zone of the catalyst containing the first washcoat layer is in the range of from 0.04 to 0.9 g/in³, based on the volume of the zone of the catalyst containing the first washcoat layer, preferably of from 0.05 to 0.8 g/in³, more preferably of from 0.15 to 0.5 g/in³, more preferably of from 0.2 to 0.35 g/in³, more preferably of from 0.23 to 0.29 g/in³, more preferably of from 0.25 to 0.27 g/in³.
66. The catalyst of any of embodiments 30 to 65, wherein the one or more platinum group metals are entirely contained in the second washcoat layer or in the second and third washcoat layers.
67. The catalyst of any of embodiments 30 to 66, wherein the one or more platinum group metals are at least in part contained in the first washcoat layer.
68. The catalyst of any of embodiments 1 to 67, wherein the substrate is a metallic substrate or a ceramic substrate, wherein preferably the substrate is a ceramic substrate, wherein more preferably the substrate comprises cordierite and/or SiC, preferably cordierite, wherein more preferably, the substrate consists cordierite and/or SIC, preferably of cordierite.
69. The catalyst of any of embodiments 33 to 68, wherein the substrate consists of two separate monoliths, wherein the first monolith is provided upstream of the second monolith, wherein the washcoat layer or washcoat layers of the upstream zone are contained on the first monolith, and the washcoat layer or washcoat layers of the downstream zone are contained on the second monolith, wherein preferably the first monolith containing the washcoat layer or washcoat layers of the upstream zone and the second monolith containing the washcoat layer or washcoat layers of the downstream zone are obtained or obtainable by sectioning of a catalyst according to any of embodiments 31 to 68 into two separate monoliths, wherein the washcoat layer or washcoat layers of the upstream zone are contained on the first monolith, and the washcoat layer or washcoat layers of the downstream zone are contained on the second monolith.
70. The catalyst of any of embodiments 1 to 69, wherein the exhaust gas stream contains hydrocarbons, preferably C1 to C20 hydrocarbons, more preferably C2 to C10 hydrocarbons.
71. Exhaust gas treatment system comprising an internal combustion engine and an exhaust gas conduit for exhaust gas from the internal combustion engine, wherein the exhaust gas conduit comprises one or more catalysts according to any of embodiments 1 to 70,preferably one, two, three or four catalysts according to any of embodiments 1 to 70.
72. The exhaust gas treatment system of embodiment 71, wherein the internal combustion engine is a compression ignition engine, preferably a diesel engine.
73. The exhaust gas treatment system of embodiment 71 or 72, wherein the internal combustion engine is a lean gasoline engine.
74. The exhaust gas treatment system of embodiment 71, wherein the internal combustion engine is powered by an oxygenated fuel, wherein the oxygenated fuel preferably comprises one or more of methanol and biofuel.
75. The exhaust gas treatment system of any of embodiments 71 to 74, wherein the system comprises one or more of an electric heater, a fuel burner, a fuel injector, a selective catalytic reduction (SCR) catalyst, an ammonia oxidation (AMOX) catalyst, a catalyzed soot filter (CSF), a diesel particulate filter (DPF), a selective catalytic reduction catalyst on filter (SCROF), and a diesel exotherm catalyst (DEC).
76. The exhaust gas treatment system of embodiment 75, comprising in consecutive order in the direction of the exhaust gas: optionally an electric heater or a fuel burner and/or a fuel injector, a catalyst according to any of embodiments 1 to 70, a catalyst according to any of embodiments 1 to 70, a selective catalytic reduction (SCR) catalyst, a selective catalytic reduction (SCR) catalyst, an optional fuel injector, a diesel exotherm catalyst (DEC), a catalyzed soot filter (CSF), a selective catalytic reduction (SCR) catalyst, and a selective catalytic reduction (SCR) catalyst.
77. The exhaust gas treatment system of embodiment 75, comprising in consecutive order in the direction of the exhaust gas: optionally an electric heater or a fuel burner and/or a fuel injector, a catalyst according to any of embodiments 1 to 70, a catalyst according to any of embodiments 1 to 70, a selective catalytic reduction (SCR) catalyst, a selective catalytic reduction (SCR) catalyst, an optional fuel injector, a diesel exotherm catalyst (DEC), a diesel particulate filter (DPF), a selective catalytic reduction (SCR) catalyst, and a selective catalytic reduction (SCR) catalyst.
78. The exhaust gas treatment system of embodiment 75, comprising in consecutive order in the direction of the exhaust gas: optionally an electric heater or a fuel burner and/or a fuel injector, a catalyst according to any of embodiments 1 to 70, a catalyst according to any of embodiments 1 to 70, a selective catalytic reduction (SCR) catalyst, a selective catalytic reduction (SCR) catalyst, an optional fuel injector, a diesel exotherm catalyst (DEC), a diesel particulate filter (DPF), a selective catalytic reduction (SCR) catalyst, and an ammonia oxidation (AMOX) catalyst.
79. The exhaust gas treatment system of embodiment 75, comprising in consecutive order in the direction of the exhaust gas: optionally an electric heater or a fuel burner and/or a fuel injector, a catalyst according to any of embodiments 1 to 70, a catalyst according to any of embodiments 1 to 70, a selective catalytic reduction (SCR) catalyst, a selective catalytic reduction (SCR) catalyst, an optional fuel injector, a catalyst according to any of embodiments 1 to 70, a diesel particulate filter (DPF), a selective catalytic reduction (SCR) catalyst, and a selective catalytic reduction (SCR) catalyst.
80. The exhaust gas treatment system of embodiment 75, comprising in consecutive order in the direction of the exhaust gas: optionally an electric heater or a fuel burner and/or a fuel injector, a catalyst according to any of embodiments 1 to 70, a catalyst according to any of embodiments 1 to 70, a selective catalytic reduction (SCR) catalyst, a selective catalytic reduction (SCR) catalyst, an optional fuel injector, a catalyst according to any of embodiments 1 to 70, a catalyst according to any of embodiments 1 to 70, wherein the substrate is a wall-flow substrate, a selective catalytic reduction (SCR) catalyst, and an ammonia oxidation (AMOX) catalyst.
81. The exhaust gas treatment system of embodiment 75, comprising in consecutive order in the direction of the exhaust gas: optionally an electric heater or a fuel burner and/or a fuel injector, a catalyst according to any of embodiments 1 to 70, a selective catalytic reduction (SCR) catalyst, a selective catalytic reduction (SCR) catalyst, a catalyzed soot filter (CSF), a selective catalytic reduction (SCR) catalyst, and a selective catalytic reduction (SCR) catalyst.
82. The exhaust gas treatment system of embodiment 75, comprising in consecutive order in the direction of the exhaust gas: optionally an electric heater or a fuel burner and/or a fuel injector, a catalyst according to any of embodiments 1 to 70, a selective catalytic reduction (SCR) catalyst, a selective catalytic reduction (SCR) catalyst, a catalyzed soot filter (CSF), a selective catalytic reduction (SCR) catalyst, and an ammonia oxidation (AMOX) catalyst.
83. The exhaust gas treatment system of embodiment 75, comprising in consecutive order in the direction of the exhaust gas: optionally an electric heater or a fuel burner and/or a fuel injector, a catalyst according to any of embodiments 1 to 70, a selective catalytic reduction (SCR) catalyst, a selective catalytic reduction (SCR) catalyst, an optional fuel injector, a catalyst according to any of embodiments 1 to 70, wherein the substrate is a wall-flow substrate, a selective catalytic reduction (SCR) catalyst, and an ammonia oxidation (AMOX) catalyst.
84. The exhaust gas treatment system of embodiment 75, comprising in consecutive order in the direction of the exhaust gas: optionally an electric heater or a fuel burner and/or a fuel injector, a catalyst according to any of embodiments 1 to 70, a selective catalytic reduction (SCR) catalyst, a selective catalytic reduction catalyst on filter (SCROF), and an ammonia oxidation (AMOX) catalyst.
85. The exhaust gas treatment system of embodiment 75, comprising in consecutive order in the direction of the exhaust gas: optionally an electric heater or a fuel burner and/or a fuel injector, a selective catalytic reduction (SCR) catalyst, an optional fuel injector, a catalyst according to any of embodiments 1 to 70, a selective catalytic reduction catalyst on filter (SCROF), and an ammonia oxidation (AMOX) catalyst.
86. The exhaust gas treatment system of embodiment 75, comprising in consecutive order in the direction of the exhaust gas: optionally an electric heater or a fuel burner and/or a fuel injector, a selective catalytic reduction (SCR) catalyst, an optional fuel injector, a catalyst according to any of embodiments 1 to 70, a catalyzed soot filter (CSF), a selective catalytic reduction (SCR) catalyst, and an ammonia oxidation (AMOX) catalyst.
87. The exhaust gas treatment system of embodiment 75, comprising in consecutive order in the direction of the exhaust gas: optionally an electric heater or a fuel burner and/or a fuel injector, a selective catalytic reduction (SCR) catalyst, an optional fuel injector, a catalyst according to any of embodiments 1 to 70, a catalyst according to any of embodiments 1 to 70, wherein the substrate is a wall-flow substrate, a selective catalytic reduction (SCR) catalyst, and an ammonia oxidation (AMOX) catalyst.
88. The exhaust gas treatment system of embodiment 75, comprising in consecutive order in the direction of the exhaust gas: optionally an electric heater or a fuel burner and/or a fuel injector, a catalyst according to any of embodiments 1 to 70, a diesel particulate filter (DPF), a selective catalytic reduction (SCR) catalyst, a selective catalytic reduction (SCR) catalyst, a selective catalytic reduction (SCR) catalyst, a selective catalytic reduction (SCR) catalyst, and an ammonia oxidation (AMOX) catalyst.
89. The exhaust gas treatment system of embodiment 75, comprising in consecutive order in the direction of the exhaust gas: optionally an electric heater or a fuel burner and/or a fuel injector, a catalyst according to any of embodiments 1 to 70, a selective catalytic reduction catalyst on filter (SCROF), a selective catalytic reduction (SCR) catalyst, and an ammonia oxidation (AMOX) catalyst.
90. The exhaust gas treatment system of embodiment 75, comprising in consecutive order in the direction of the exhaust gas: optionally an electric heater or a fuel burner and/or a fuel injector, a catalyst according to any of embodiments 1 to 70, a selective catalytic reduction (SCR) catalyst, a selective catalytic reduction catalyst on filter (SCROF), a selective catalytic reduction (SCR) catalyst, and an ammonia oxidation (AMOX) catalyst.
91. Method for the treatment of an exhaust gas stream containing one or more of formaldehyde, nitrogen oxide (NO), and hydrocarbons, the method comprising
   (A) providing an exhaust gas stream comprising one or more of formaldehyde, nitrogen oxide (NO), and hydrocarbons;
   (B) directing the exhaust gas stream provided in (A) through a catalyst according to any of embodiments 1 to 70.
92. The method of embodiment 91, wherein the exhaust gas stream provided in (A) comprises one or more sulfur-containing compounds, preferably SO₂ and/or SO₃.
93. The method of embodiment 91 or 92, wherein the exhaust gas stream provided in (A) comprises NOx.
94. The method of any of embodiments 91 to 93, wherein the exhaust gas stream provided in (A) comprises CO.
95. The method of any of embodiments 91 to 94, wherein the exhaust gas stream provided in (A) comprises formaldehyde.
96. The method of any of embodiments 91 to 95, wherein the exhaust gas stream provided in
97. The method of any of embodiments 91 to 96, wherein the exhaust gas stream provided in (A) comprises hydrocarbons, preferably C1 to C20 hydrocarbons, more preferably C2 to C10 hydrocarbons.
98. Use of a catalyst according to any of embodiments 1 to 70 for the oxidation of one or more of formaldehyde, nitrogen oxide (NO), and hydrocarbons, preferably for the oxidation of one or more of formaldehyde, nitrogen oxide (NO), and hydrocarbons in an exhaust gas stream, more preferably for the oxidation of one or more of formaldehyde, nitrogen oxide (NO), and hydrocarbons in the exhaust gas stream of an internal combustion engine, more preferably for the oxidation of one or more of formaldehyde, nitrogen oxide (NO), and hydrocarbons in the exhaust gas stream of a compression ignition engine, more preferably for the oxidation of one or more of formaldehyde, nitrogen oxide (NO), and hydrocarbons in the exhaust gas stream of a diesel engine.

The present invention is further illustrated by the following examples.

### Experimental Section

### EXAMPLE 1

### Preparation of a Catalyst for the Treatment of an Exhaust Gas Stream Containing One or More of Formaldehyde, Nitrogen Oxide (NO), and Hydrocarbons

A catalyst was prepared by coating platinum group metal (PGM)-containing front zone and base metal oxide (BMO)-containing rear zone segments separately on 1″ diameter cordierite honeycomb substrates and then combining the coated cores sequentially for subsequent S aging and testing. The front zone segment was prepared by first combining Pt (using an aqueous solution containing an ammine stabilized hydroxo Pt(IV) complex, said solution having a Pt content in the range of from 10 to 20 weight-%), Pd (using Pd nitrate), Beta zeolite and a commercial alumina support powder comprising 5 wt.-% silica and having a BET surface area of approximately 150 m²/g and a pore volume of about 0.6 cm³/g in an aqueous slurry composition using techniques commonly known in the art. After coating the slurry onto a cordierite substrate followed by drying and calcination at 590° C., a 1″ diameter by 1.2″ long core was subsequently cut from the monolith to be used as the front zone segment. The Pt-Pd weight ratio was 2:1, and total Pt-Pd loading was 75 g/ft³ of monolith volume. The washcoat loading of the PGM-containing layer was 2.9 g/in³, containing about 91 wt.-% alumina and about 9 wt.-% Beta zeolite. The BMO-containing rear zone segment was prepared by first combining a commercial zirconia support powder comprising 9 wt.-% La₂O₃ and having a BET surface area of approximately 75 m2/g with solutions of Mn nitrate and Ce nitrate in de-ionized (Di) water. After milling the resulting mixture to a particle size suitable for coating, boehmite alumina binder was added. The resulting slurry was then coated onto a 1″ diameter by 1.8″ long cordierite substrate which was dried and subsequently calcined at 590° C. for 1 h. Total washcoat loading of the BMO-containing layer was 1.9 g/in³ of monolith volume comprising 9.2% by weight Mn, 9.2% by weight Ce, 3% by weight Al₂O₃ binder and balance La₂O₃-stabilized ZrO₂ (1.5 g/in³).

Based on the total catalyst comprising the front and rear zone segments, the respective loadings of Mn and Ce in the catalyst, calculated as the respective element, was 0.114 g/in³.

### EXAMPLE 2

### Preparation of a Catalyst for the Treatment of an Exhaust Gas Stream Containing One or More of Formaldehyde, Nitrogen Oxide (NO), and Hydrocarbons

A catalyst was prepared in the same manner as described in Example 1 except that the total washcoat loading of the BMO-containing rear zone segment was 2.3 g/in³ and the washcoat loading of the La₂O₃-stabilized ZrO₂ support was 1.8 g/in³. Based on the total catalyst comprising the front and rear zone segments, the respective loadings of Mn and Ce in the catalyst, calculated as the respective element, was 0.138 g/in³.

### EXAMPLE 3

### Preparation of a Catalyst for the Treatment of an Exhaust Gas Stream Containing One or More of Formaldehyde, Nitrogen Oxide (NO), and Hydrocarbons

A catalyst was prepared by coating PGM-containing front zone and BMO-containing rear zone segments separately on 1″ diameter cordierite honeycomb substrates and then combining the coated cores sequentially for subsequent S aging and testing. The front zone segment was prepared identically to the previous examples. The rear zone segment was prepared by first combining a commercial zirconia support powder comprising 9 wt.-% La₂O₃ and having a BET surface area of approximately 75 m²/g and a pore volume of about 0.5 cm³/g with a solution of Mn nitrate in de-ionized (Di) water. After milling the resulting mixture to a particle size suitable for coating, boehmite alumina binder was added. The resulting slurry was then coated onto a 1″ diameter by 1.8″ long cordierite substrate which was dried and subsequently calcined at 590° C. for 1 h. Total washcoat loading was 2.3 g/in³ of monolith volume comprising 9.4% by weight Mn, 3% by weight Al₂O₃ binder and balance La₂O₃-stabilized ZrO₂ (1.8 g/in³).

Based on the total catalyst comprising the front and rear zone segments, the loading of Mn in the catalyst, calculated as the element, was 0.138 g/in³.

### EXAMPLE 4

### Preparation of a Catalyst for the Treatment of an Exhaust Gas Stream Containing One or More of Formaldehyde, Nitrogen Oxide (NO), and Hydrocarbons

A catalyst was prepared in the same manner as described in Example 3 except that the total washcoat loading of the BMO-containing rear zone segment was 3.4 g/in³ and the washcoat loading of the La₂O₃-stabilized ZrO₂ support was 3.0 g/in³. Based on the total catalyst comprising the front and rear zone segments, the loading of Mn in the catalyst, calculated as the element, was 0.204 g/in³.

### EXAMPLE 5

### Aging and Catalytic Testing

Sulfur aging (S aging) of catalysts of Examples 1-4 was accomplished on a lab reactor at 300° C. in a feed comprising 15 ppm SO₂, 150 ppm NO, 10% O₂ and 5% H₂O. The flow through the catalyst measured as space velocity was 35,000/h. The exposure time was 88 minutes corresponding to a target S exposure amount of 1 g (S)/L of monolith volume. Desulfation was accomplished at 750° C. under isothermal conditions for 30 minutes in a feed comprising 10% O₂ and 5% H₂O. Flow through the catalyst as measured by space velocity was 32,000/h.

After sulfation and desulfation, the samples were tested for formaldehyde (HCHO) light-off performance using a feed comprising 180 ppm NO, 1000 ppm CO, 25 ppm HCHO, 100 ppm-C1 from C₂H₄, 190 ppm-C1 from C₁₀H₂₂, 10% O₂, 10% H₂O and 10% CO₂. Flow through the catalyst as measured by space velocity was 50,000/h. The samples were placed in the reactor and first equilibrated at 80° C. in flowing air. The formaldehyde-containing feed was then introduced and temperature ramping initiated to 300° C. at a ramp rate of 15° C./min. Formaldehyde concentration was monitored by FTIR during the light-off ramp and conversion performance vs. temperature was subsequently calculated from these measurements.

The results for the catalysts of Examples 1 and 2 are shown in FIG. 1. The formaldehyde oxidation performance at low temperatures was higher for the catalyst of Example 2 with higher total washcoat loading in the BMO-containing rear zone.

The results for the catalysts of Examples 3 and 4 are shown in FIG. 2. The low temperature formaldehyde oxidation performance was higher for the catalyst of Example 4 having a higher total washcoat loading in the BMO-containing rear zone.

As can be taken from the results, the catalyst according to the present invention can comprise Mn supported on a support material, e.g. refractory zirconia, in low or high amounts. In particular low amounts of Mn can be advantageous for engine operation by limiting pressure drop in the exhaust system, whereas increasing the amount of the catalytically active Mn component is critical for maximizing HCHO oxidation performance, particularly after exposure to the harmful effects of S present in engine exhaust. In particular, for a catalyst comprising 10 wt.-% Mn and 10 wt.-% Ce supported on 9 wt.-% La₂O₃-stabilized ZrO₂, it has been found that increasing the zirconia support loading by 20% from 1.5 to 1.8 g/in³ had a significant positive impact on formaldehyde (HCHO) oxidation performance after sulfation and desulfation. For a related catalyst comprising Mn without Ce, even higher performance was achieved when the zirconia support loading was increased to 3 g/in³.

### EXAMPLE 6

### Preparation of a Catalyst for the Treatment of an Exhaust Gas Stream Containing One or More of Formaldehyde, Nitrogen Oxide (NO), and Hydrocarbons

A catalyst was prepared in the same manner as described in Example 1 except that the Pt—Pd weight ratio of the front zone was 4:1, the total Pt—Pd loading was 180 g/ft³ of monolith volume, and the BMO-containing layer comprised 10% by weight Mn and 10% by weight Ce, 3% by weight Al₂O₃ binder and balance La₂O₃-stabilized ZrO₂.

### Comparative Example 7

Preparation of a copper-containing catalyst for the treatment of an exhaust gas stream containing one or more of formaldehyde, nitrogen oxide (NO), and hydrocarbons

A catalyst was prepared in the same manner as described in Example 6 except that the BMO-containing layer comprised 10% by weight Mn, 10% by weight Cu, and 10% by weight Ce, 3% by weight Al₂O₃ binder and balance La₂O₃-stabilized ZrO₂.

### Example 8: Aging and Catalytic Testing

Steam aging of catalysts of Example 6 and comparative Example 7 was conducted at 800° C. for 16h.

After steam aging, the samples were tested for formaldehyde (HCHO) light-off performance using a feed comprising 180 ppm NO, 1000 ppm CO, 25 ppm HCHO, 100 ppm-C1 from C₂H₄, 190 ppm-C1 from C₁₀H₂₂, 10% O₂, 10% H₂O and 10% CO₂. Flow through the catalyst as measured by space velocity was 50,000/h. The samples were placed in the reactor and first equilibrated at 80° C. in flowing air. The formaldehyde-containing feed was then introduced and temperature ramping initiated to 300° C. at a ramp rate of 15° C./min. Formaldehyde concentration was monitored by FTIR during the light-off ramp and conversion performance vs. temperature was subsequently calculated from these measurements.

The results for the catalysts of Example 6 and comparative Example 7 are shown in FIG. 3.

The formaldehyde oxidation performance at low temperatures was higher for the catalyst of Example 6, wherein the first washcoat loading does not contain Cu, compared to comparative Example 7, wherein the first washcoat loading contains Cu.

### DESCRIPTION OF THE FIGURES

FIG. 1: shows the formaldehyde (HCHO) oxidation performance after sulfation and 750° C. desulfation for the catalysts of Examples 1 and 2. Both samples comprised a 2:1 Pt—Pd front zone at 75 g/ft³ and a rear zone comprising 10 wt.-% Mn and 10 wt.-% Ce supported on 9 wt.-% La₂O₃-stabilized ZrO₂. The samples differ in the amount of total washcoat loaded onto the monolith for the rear zone.

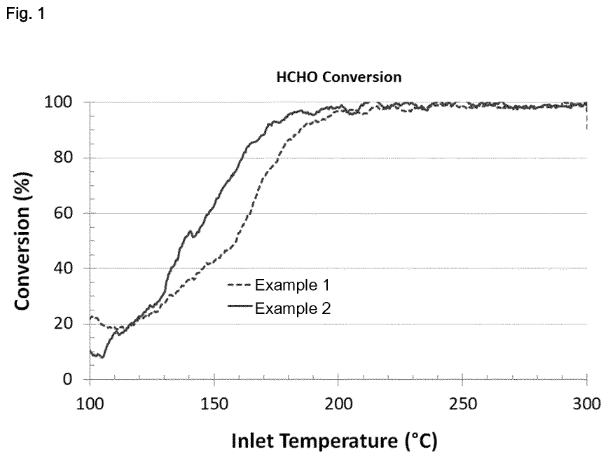

FIG. 2: shows the formaldehyde (HCHO) oxidation performance after sulfation and 750° C. desulfation for the catalysts of Examples 3 and 4. Both samples comprised a 2:1 Pt—Pd front zone at 75 g/ft³ and a rear zone comprising 10 wt.-% Mn supported on 9 wt.-% La₂O₃-stabilized ZrO₂. The samples differ in the amount of total washcoat loaded onto the monolith for the rear zone.

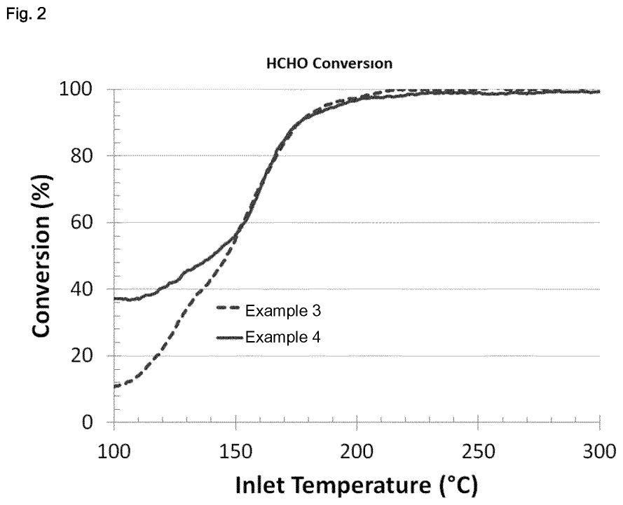

FIG. 3: shows the formaldehyde (HCHO) oxidation performance after steam aging (800° C., 16 h) for the catalysts of Examples 6 and Comparative Example 7.

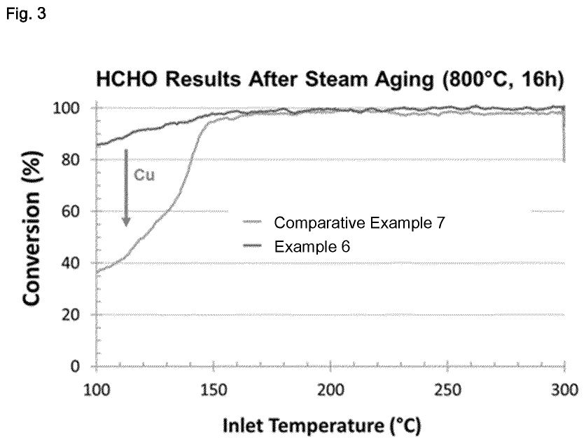

### CITED LITERATURE

WO 2022/047132 A1
U.S. Pat. No. 10,598,061 B2
U.S. Pat. No. 10,392,980 B2
WO 2021/198680 A1
US 2019/262772 A1
US 2017/009623 A1
US 2015/352493 A1
US 2018/318805 A1
M. C. Álvarez-Galvan et al. in Applied Catalysis B. 2004, 51, 83-91

1. A catalyst for the treatment of an exhaust gas stream containing one or more of formaldehyde, nitrogen oxide (NO), and hydrocarbons, the catalyst comprising
a first washcoat layer comprising Mn, and a substrate,
wherein the substrate has an inlet end through which the exhaust gas stream may enter the catalyst, and an outlet end through which the exhaust gas stream may exit the catalyst,
wherein the catalyst further comprises one or more platinum group metals comprising Pt, Pd, or Pt and Pd, wherein the one or more platinum group metals are at least in part contained in one or more of:
(a) the first washcoat layer, and
(b) an optional second washcoat layer, or
(c) optional second and third washcoat layers,

2. The catalyst of claim 1, wherein the first washcoat layer comprises a particulate support material, wherein Mn is supported on the particulate support material.

3. The catalyst of claim 1, or wherein the first washcoat layer is substantially free of Cu.

4. The catalyst of claim 1, wherein the catalyst comprises Pt, calculated as the element, at a loading in the range of from 2 to 250 g/ft³.

5. The catalyst of claim 1, wherein the catalyst comprises Pd, calculated as the element, at a loading in the range of from 5 to 100 g/ft³.

6. The catalyst of claim 1, wherein the one or more platinum group metals are supported on a particulate support material.

7. The catalyst of claim 1, wherein the second washcoat layer comprises a hydrocarbon trap material, wherein the hydrocarbon trap material comprises a molecular sieve.

8. The catalyst of claim 1, wherein the one or more platinum group metals are entirely contained in the second washcoat layer.

9. The catalyst of claim 1, wherein the catalyst comprises a second washcoat layer, wherein the catalyst displays a zoned arrangement of the first and second washcoat layers, and
wherein the second washcoat layer is provided on the substrate along its axial length starting from the inlet end of the substrate, wherein the first washcoat layer is provided on the substrate along its axial length starting from the outlet end of the substrate, wherein the length of the first washcoat layer is less than the axial length of the substrate such as to create an upstream zone comprising the second washcoat layer and a downstream zone comprising the first washcoat layer, wherein the one or more platinum group metals are at least in part contained in the second washcoat layer.

10. The catalyst of claim 1, wherein the catalyst comprises a second washcoat layer, wherein the catalyst displays a zoned arrangement of the first and second washcoat layers, and
wherein the second washcoat layer is provided on the substrate along its axial length starting from the inlet end of the substrate, wherein the first washcoat layer is provided on the substrate along its axial length starting from the outlet end of the substrate, wherein the length of the second washcoat layer is less than the axial length of the substrate such as to create an upstream zone comprising the second washcoat layer and a downstream zone comprising the first washcoat layer, wherein the one or more platinum group metals are at least in part contained in the second washcoat layer.

11. The catalyst of claim 1, wherein the catalyst comprises a second washcoat layer, wherein the catalyst displays a zoned arrangement of the first and second washcoat layers, and
wherein the second washcoat layer is provided on the substrate along its entire length, wherein the first washcoat layer is provided on the second washcoat layer along its axial length starting from the outlet end of the substrate, wherein the length of the first washcoat layer is less than the axial length of the substrate such as to create an upstream zone comprising the second washcoat layer and a downstream zone comprising the first washcoat layer over the second washcoat layer, wherein the one or more platinum group metals are at least in part contained in the second washcoat layer.

12. The catalyst of claim 1, wherein the catalyst comprises a second washcoat layer, wherein the catalyst displays a zoned arrangement of the first and second washcoat layers, and
wherein the first washcoat layer is provided on the substrate along its entire length, wherein the second washcoat layer is provided on the first washcoat layer along its axial length starting from the inlet end of the substrate, wherein the length of the second washcoat layer is less than the axial length of the substrate such as to create an upstream zone comprising the second washcoat layer over the first washcoat layer and a downstream zone comprising the first washcoat layer, wherein the one or more platinum group metals are at least in part contained in the second washcoat layer.

13. Exhaust gas treatment system comprising an internal combustion engine and an exhaust gas conduit for exhaust gas from the internal combustion engine, wherein the exhaust gas conduit comprises a catalyst according to claim 1.

14. The exhaust gas treatment system of claim 13, wherein the system comprises one or more of an electric heater, a fuel burner, a fuel injector, a selective catalytic reduction (SCR) catalyst, an ammonia oxidation (AMOX) catalyst, a catalyzed soot filter (CSF), a diesel particulate filter (DPF), a selective catalytic reduction catalyst on filter (SCROF), and a diesel exotherm catalyst (DEC).

15. Method for the treatment of an exhaust gas stream containing one or more of formaldehyde, nitrogen oxide (NO), and hydrocarbons, the method comprising
(A) providing an exhaust gas stream comprising one or more of formaldehyde, nitrogen oxide (NO), and hydrocarbons;
(B) directing the exhaust gas stream provided in (A) through a catalyst according to claim 1.

16. Use of a catalyst according to claim 1, for the oxidation of one or more of formaldehyde, nitrogen oxide (NO), and hydrocarbons.
